(19) United States
(12) Patent Application Publication
(10) Pub. No.: US 2005/0246091 A1
(43) Pub. Date: Nov. 3, 2005

(54) Curvature radius estimating apparatus and method

(75) Inventors: Koichi Kuroda, Yokohama-shi (JP); Takuo Ishiwaka, Yokohama-shi (JP); Yasunori Maruyama, Yokosuka-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/100,465

(22) Filed: Apr. 7, 2005

(30) Foreign Application Priority Data
Apr. 28, 2004 (JP) P2004-133240
May 12, 2004 (JP) P2004-142199

(51) Int. Cl. G06F 17/00

(52) U.S. Cl. 701/200; 701/1

(57) ABSTRACT

A curvature radius calculator employs point sequence data of map information representing a road shape, for calculation to determine a curvature radius of a curved interval of a travel path of a vehicle, a shape pattern decider employs the point sequence data to decide a shape pattern of the curved interval, a curvature radius corrector corrects the curvature radius, commensurately with a decision result of the shape pattern decider, and a curved interval extractor selects prescribed intervals of the travel path as targets, and extracts therefrom an interval meting preset conditions on an average of link lengths representing spacings between sequential two points of the point sequence data, respectively; an extreme as a maximum or minimum of the link lengths, and an average of link angles representing angles between adjacent two links, respectively, allowing the curvature radius calculator to use point sequence data of the extracted curved interval, to acquire a curvature radius of the curved interval.

### BACKGROUND OF THE INVENTION

1. Field of the Invention

The present invention relates to an estimation apparatus and an estimation method of “a curvature in terms of the radius of curvature” (hereafter simply “curvature radius”), and in particular, to a curvature radius estimating apparatus configured to estimate, and a curvature radius estimating method of estimating, the curvature radius of a curved interval of a vehicle travel path depending on “a set of data on a sequence of points associated therewith” (hereafter “sequence point data”) derived from map information such as for a vehicle-mounted navigation system.

2. Description of Relevant Art

Vehicle-mounted navigation systems configured to exemplarily display a map, set a travel path thereon, and guide through the travel path, have been accepted and widely used by many users by virtue of convenience thereof. In the field of such vehicle-mounted navigation systems, various research and development have been extensively conducted to realize more convenient and additional functions, including approaches to utilize point sequence data included in map information so as to calculate a curvature radius of a curved interval of a vehicle travel path, to display it on a navigation screen for assistance to a driver, and/or to utilize it for automatic control of a vehicle behavior (see Japanese Patent Application Laid-Open Publication No. 11-2528 and Japanese Patent Application Laid-Open Publication No. 2000-321086).

The Japanese Patent Application Laid-Open Publication No. 11-2528 discloses a technique to utilize three points, i.e., first, second, and third points which are included in points constituting a point sequence representing a vehicle travel path and which are present ahead of a vehicle along the travel path, to calculate a curvature radius of a curved interval represented by these three points based on distances between the first and second points and the second and third points of the point sequence, and to correct the calculated curvature radius commensurately with a distance between the second point and a center position of the curved interval.

In turn, the Japanese Patent Application Laid-Open Publication No. 2000-321086 discloses a technique to utilize a spline function to interpolate coordinate values of four or more successive points included in points constituting a point sequence representing a vehicle travel path to acquire a curvature radius of a curved interval of the travel path.

### SUMMARY OF THE INVENTION

In the techniques described in the Japanese Patent Application Laid-Open Publication No. 11-2528 and Japanese Patent Application Laid-Open Publication No. 2000-321086, it is possible to acquire a curvature radius of a curved interval represented by points constituting the point sequence in a precise manner to a certain extent, insofar as the points are arranged in a regular manner to a certain extent. However, in point sequence data actually included in map information, points constituting the point sequence are not regularly arranged in accordance with a preset rule, and it is likely that link lengths representing spacings between adjacent two points of the point sequence and link angles representing angles defined by adjacent two links, respectively, have a larger variance depending on shape patterns of curved intervals.

Thus, it is not necessarily possible to calculate a curvature radius of a curved interval with good precision insofar as based on the techniques described in the Japanese Patent Application Laid-Open Publication No. 11-2528 and Japanese Patent Application Laid-Open Publication No. 2000-321086, and improvement is accordingly desired.

Namely, insofar as based on the technique disclosed in the Japanese Patent Application Laid-Open Publication No. 11-2528 to calculate a curvature radius of a curved interval by using three points present ahead of a vehicle along a vehicle travel path, it is difficult to determine a curved interval with good precision, and it is rather feared that a singular curved interval is regarded as multiple curved intervals the curvature radii of which are to be calculated and displayed on a screen, respectively, thereby not only complicating operations but also giving incongruent feeling to a driver.

The present invention has been made in view of the foregoing points, and it is therefore an object of the present invention to provide a curvature radius estimating apparatus and a curvature radius estimating method capable of estimating a curvature radius of a curved interval with good precision even when the curved interval is in a shape pattern accompanied by a large variance of sequential points included in point sequence data therefor.

It is another object of the present invention to provide a curvature radius estimating apparatus and a curvature radius estimating method capable of extracting a singular curved interval with good precision and estimating a curvature radius thereof even for a road shape accompanied by a large variance of sequential points included in point sequence data therefor.

To achieve the object, according to an aspect of the invention, a curvature radius estimating apparatus comprises: a curvature radius calculator configured to use point sequence data which is included in map information and represents a road shape, to calculate a curvature radius of a curved interval of a travel path of a vehicle; a shape pattern decider configured to use the point sequence data to decide a shape pattern of the curved interval of which the curvature radius is calculated by the curvature radius calculator; and a curvature radius corrector configured to correct the curvature radius calculated by the curvature radius calculator, commensurately with a decision result by the shape pattern decider.

To achieve the object described, according to another aspect of the invention, a curvature radius estimating method comprises: using point sequence data which is included in map information and represents a road shape, for calculation to determine a curvature radius of a curved interval of a travel path of a vehicle; using the point sequence data to decide a shape pattern of the curved interval of which t he curvature radius is calculated by the calculation; and correcting the curvature radius calculated by the calculation, commensurately with a decision result by the deciding operation.

To achieve the object described, according to still another aspect of the invention, a curvature radius estimating method uses point sequence data which is included in map information and represents a road shape, for calculation to determine a curvature radius of a curved interval of a travel path of a vehicle; the method comprising: selecting a preset interval of the travel path of the vehicle as a target interval, and extracting, as a curved interval from the target interval, an interval meeting preset conditions on: an averaged value of link lengths representing spacings between sequential two points included in the point sequence data, respectively; a maximum value or minimum value of the link lengths; and an averaged value of link angles representing angles defined by adjacent two links, respectively; and using the point sequence data within the curved interval extracted by said extracting, to acquire a curvature radius of the curved interval.

### BRIEF DESCRIPTION OF THE ACCOMPANYING DRAWINGS

The above and further objects, features, and advantages of the present invention will appear more fully from the detailed description of the preferred embodiments, when the same is read in conjunction with the accompanying drawings, in which:

FIG. 1 is a block diagram of a constitution of a vehicle-mounted navigation system;

FIG. 2 is a functional block diagram of a configuration of a curvature radius estimating apparatus according to a first embodiment of the present invention realized as one function of the vehicle-mounted navigation system;

FIG. 3 is a schematic explanatory view of an example of previewed point sequence data, to explain an example of a curved interval requiring correction of a curvature radius calculated therefor;

FIG. 4 is a schematic explanatory view of another example of previewed point sequence data, to explain another example of a curved interval requiring correction of a curvature radius calculated therefor;

FIG. 5 is a flowchart of a control procedure for the whole curvature radius estimating apparatus according to the present invention;

FIG. 6 is a flowchart of a control procedure corresponding to a shape pattern shown in FIG. 3, to explain processing for deciding a shape pattern of a curved interval and for correcting a calculated curvature radius;

FIG. 7 is a flowchart of a control procedure corresponding to a shape pattern shown in FIG. 4, to explain processing for deciding a shape pattern of a curved interval and for correcting a calculated curvature radius;

FIG. 8 is a schematic view of still another example of previewed point sequence data, to explain processing for determining a curved interval as a shape pattern decision target;

FIG. 9 is a schematic view of yet another example of previewed point sequence data, to explain another example of processing for determining a curved interval as a shape pattern decision target;

FIG. 10 is an explanatory view of another example of a deciding method for the shape pattern shown in FIG. 3;

FIG. 11 is a graph of a relationship between a maximum value of lengths of links preceding to and following a curved interval and a proportional constant K₁, to explain an example of a method for correcting a calculated curvature radius for the shape pattern shown in FIG. 3;

FIG. 12 is a graph of a relationship between an averaged link length within a target portion and a proportional constant K₂, to explain an example of a method for correcting a calculated curvature radius for the shape pattern shown in FIG. 4;

FIG. 13 is a graph of a relationship between an averaged link angle within a target portion and the proportional constant K₂, to explain another example of a method for correcting a calculated curvature radius for the shape pattern shown in FIG. 4;

FIG. 14 is a functional block diagram of a configuration of a curvature radius estimating apparatus according to a second embodiment of the present invention realized as one function of the vehicle-mounted navigation system;

FIG. 15 is a schematic view of an example of previewed point sequence data, to explain an outline of processing for extracting a curved interval;

FIG. 16 is a schematic view of another example of previewed point sequence data, to explain an outline of processing for extracting a curved interval;

FIG. 17 is a flowchart of a control procedure of the whole curvature radius estimating apparatus according to the present invention;

FIG. 18 is a flowchart of processing for determining an ending point of a curve extraction target interval;

FIG. 19 is a flowchart of processing for extracting a small-R curved interval having a small curvature radius level;

FIG. 20 is a flowchart of processing for extracting a medium-R curved interval having a medium curvature radius level;

FIG. 21 is a flowchart of processing for extracting a large-R curved interval having a large curvature radius level;

FIG. 22 is a schematic view of still another example of previewed point sequence data, to explain curved interval extraction processing for a long curved interval;

FIG. 23 is a schematic view of yet another example of previewed point sequence data, explain curved interval extraction processing for an S-shaped curved interval;

FIG. 24 is a schematic view of another example of previewed point sequence data, to explain curved interval extraction processing for a road including an intersection;

FIG. 25 is a schematic view of another example of previewed point sequence data, to explain curved interval extraction processing where a point sequence for a curve extraction target interval includes a small number of points;

FIG. 26 is a schematic view of another example of previewed point sequence data, to explain curved interval extraction processing where a location of a certain one of sequential points constituting a point sequence representing a travel path of own vehicle is deviated from a center line of a road;

FIG. 27 is a schematic view of another example of previewed point sequence data, to explain curved interval extraction processing where a location of a point as a curve exit among points constituting a point sequence representing a travel path of own vehicle is deviated from a center line of a road;

FIG. 28 is a flowchart of processing for setting an ending point of a curve extraction target interval according to a third embodiment of the present invention;

FIG. 29 is a schematic view of another example of previewed point sequence data, to explain processing for correcting a curved interval extracted in case of a short rectilinear distance between curved intervals; and

FIG. 30 is a flowchart of processing for correcting a curved interval according to a fourth embodiment of the present invention.

### DETAILED DESCRIPTION OF THE PREFERRED EMBODIMENTS

There will be described preferred embodiments of the present invention in detail, with reference to the accompanying drawings.

(First Embodiment)

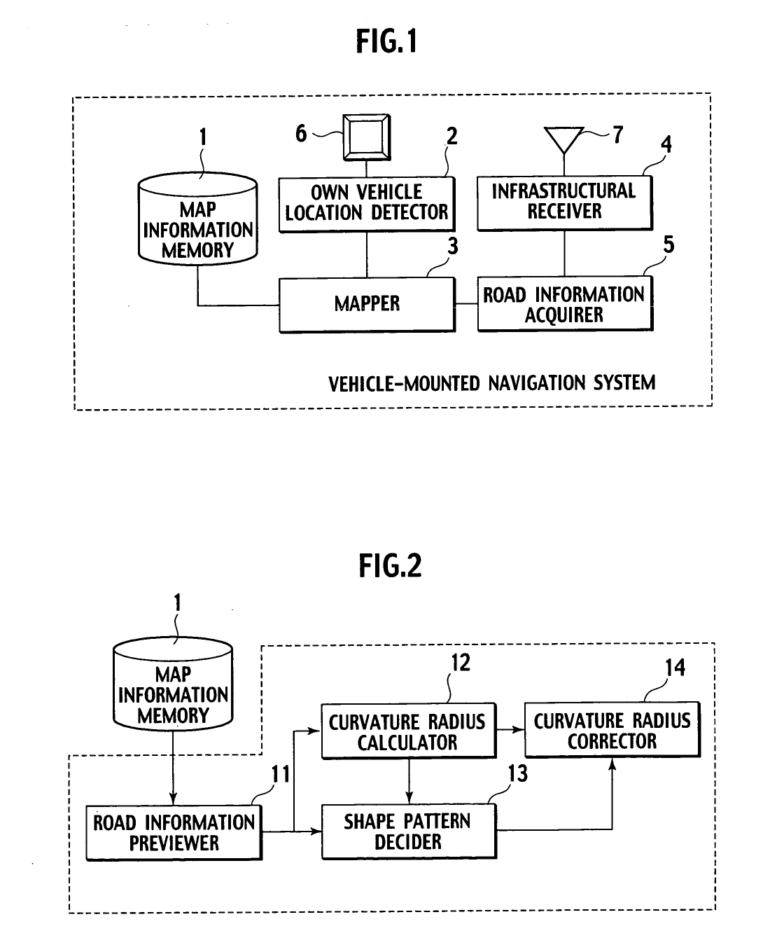

The present invention is realized as a function of a vehicle-mounted navigation system shown in FIG. 1, for example. This vehicle-mounted navigation system is mounted on a vehicle to exemplarily display a map, set a travel path, guide through the travel path, and present various information useful for own vehicle driving, and is configured with a map information memory 1, an own vehicle location detector 2, a mapper 3, an infrastructural receiver 4, and a road information acquirer 5.

The map information memory 1 includes a recording medium such as a DVD-ROM (Digital Versatile Disc-Read Only Memory) including map information recorded therein, and is configured to retrieve necessary map information from the recording medium. The map information includes point sequence data representing a road shape, and other additional data, and the point sequence data includes data of points, i.e., data of nodes representing points on the map, and data of links which couple the nodes, respectively.

The own vehicle location detector 2 is configured to detect a current location of a vehicle (own vehicle) on which the vehicle-mounted navigation system is mounted, and has a GPS antenna 6 configured to receive a signal transmitted from a GPS (Global Positioning System) satellite. This own vehicle location detector 2 is further configured to acquire an absolute location and an orientation of own vehicle based on a GPS signal received by the GPS antenna 6, and to correct them by utilizing information acquired by autonomous navigation based on outputs from various sensors including a geomagnetic sensor, a gyroscope, and a distance sensor, to detect a precise current location of own vehicle.

The mapper 3 is configured to match a current location of own vehicle detected by the own vehicle location detector 2 onto a corresponding road included in a map retrieved from the map information memory 1.

The infrastructural receiver 4 is configured to receive information from a narrow range information providing infrastructure such as beacons located on a road, and a wide range information providing infrastructure such as FM multiplex broadcast, and includes an antenna 7, a converter, and the like.

The road information acquirer 5 is configured to acquire the map information retrieved from the map information memory 1 and matched in terms of the own vehicle location by the mapper 3 as well as information provided from the information providing infrastructures and received by the infrastructural receiver 4. The present invention is realized as one function of the road information acquirer 5. Namely, realized in the road information acquirer 5 is a function as a curvature radius estimating apparatus configured to use point sequence data included in map information and representing a road shape, to estimate a curvature radius of a curved interval of a travel path of own vehicle.

FIG. 2 is a functional block diagram of an outline of the curvature radius estimating apparatus to be realized by the road information acquirer 5 of the vehicle-mounted navigation system. As shown in FIG. 2, the curvature radius estimating apparatus of this embodiment includes a road information previewer 11, a curvature radius calculator 12, a shape pattern decider 13, and a curvature radius corrector 14.

The road information previewer 11 is configured to acquire, from the map information memory 1, point sequence data included in map information around an own vehicle location, and to expand this point sequence data.

The curvature radius calculator 12 is configured to use the point sequence data around the own vehicle location as expanded by the road information previewer 11, to calculate a curvature radius of a curved interval of the travel path of own vehicle.

The shape pattern decider 13 is configured to use the point sequence data around the own vehicle location as expanded by the road information previewer 11, particularly the point sequence data within and around a curved interval the curvature radius of which is calculated by the curvature radius calculator 12, to decide whether or not the shape of the curved interval the curvature radius of which is calculated by the curvature radius calculator 12 is a shape pattern requiring a curvature radius correction.

The curvature radius corrector 14 is configured to correct the curvature radius calculated by the curvature radius calculator 12, when it is decided that the shape of the curved interval the curvature radius of which is calculated by the curvature radius calculator 12 is a shape pattern requiring a curvature radius correction by the shape pattern decider 13.

The curvature radius estimating apparatus of this embodiment is configured to estimate a curvature radius of a curved interval of a travel path of own vehicle with good precision, based on the above processing in the functional components. Further, the information on curvature radii estimated by the curvature radius estimating apparatus are handled by the road information acquirer 5 of the vehicle-mounted navigation system as information useful for own vehicle driving, and are exemplarily utilized so as to be displayed on a navigation screen to assist a driver in a driving operation, and to automatically control a vehicle behavior.

There will be now briefly explained an outline of processing in the curvature radius estimating apparatus of this embodiment as described above.

Because point sequence data included in map information to be handled in a current vehicle-mounted navigation system is basically prepared as data for map display, the point sequence data is not provided in a structure where points included in a point sequence representing a road shape are plotted in accordance with a preset rule, and it is likely that link lengths representing spacings between adjacent two points of the point sequence and link angles representing angles defined by adjacent two links, respectively, have a larger variance depending on shape patterns of curved intervals. As such, it is probable that, when curvature radii of curved intervals are calculated by using such point sequence data, calculated curvature radii are considerably different from actual curvature radii.

Namely, there is calculated a curvature radius R by the following equation (1), in which LS represents a sum of link lengths within an extracted curved interval, and θS represents a sum of link angles within the extracted curved interval:
R=LS/θS (1)

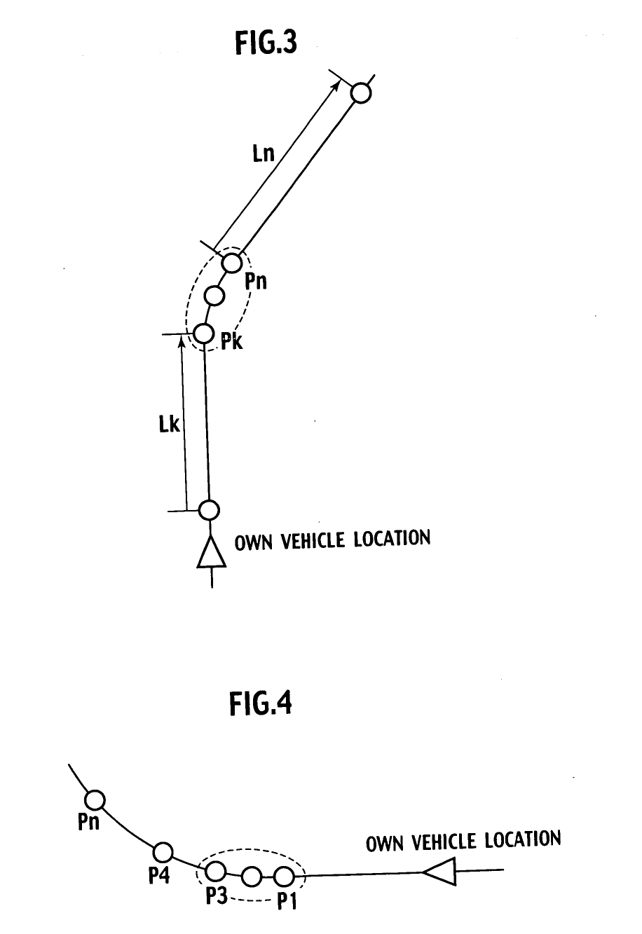

Concretely, as a tendency where curvature radii calculated by using point sequence data are different from actual curvature radii, it is frequent that points constituting a point sequence are coarsely plotted in case of a short curved interval in a doglegged shape (an interval from a point Pₖ to a point Pₙ in FIG. 3) interposed between long straight intervals as shown in FIG. 3, for example. Thus, in the curved interval in such a shape pattern, the curvature radius to be calculated by using the point sequence data tends to become larger than an actual curvature radius.

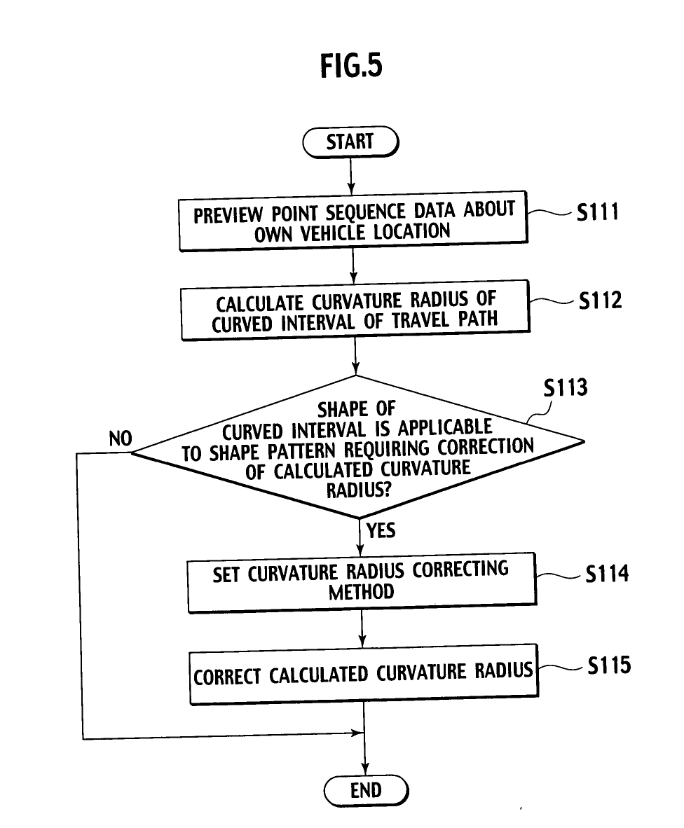

Contrary, it is frequent that points constituting a point sequence of a curved interval are partly densely plotted (along a portion from a point P₁ to a point P₃ in FIG. 4) in case of a long curved interval having a slightly large curvature radius between about 150R and 300R as shown in FIG. 4, for example. Thus, in the curved interval in such a shape pattern, the curvature radius to be calculated by using the point sequence data tends to become smaller than an actual curvature radius.

Thus, in the curvature radius estimating apparatus of this embodiment, the shape pattern decider 13 is configured to decide whether or not a shape of a curved interval the curvature radius of which is calculated by the curvature radius calculator 12 by using the point sequence data, is applicable to either of the two shape patterns, to decreasingly correct the curvature radius calculated by the curvature radius calculator 12 when the curved interval is applicable to the former shape pattern, and to increasingly correct the curvature radius calculated by the curvature radius calculator 12 when the curved interval is applicable to the latter shape pattern, thereby improving precision in estimating a curvature radius of a curved interval of a travel path of own vehicle.

There will be explained an example of control procedures in the curvature radius estimating apparatus of this embodiment, with reference to flowcharts of FIG. 5 through FIG. 7. Note that the control procedures are invoked from a main program of the vehicle-mounted navigation system and repeatedly executed, at constant time intervals (such as 100 ms).

Firstly, the control procedure for the whole curvature radius estimating apparatus of this embodiment will be explained along the flowchart of FIG. 5.

At step S111, the road information previewer 11 acquires point sequence data around an own vehicle location from the map information memory 1 of the vehicle-mounted navigation system, and previews the acquired point sequence data.

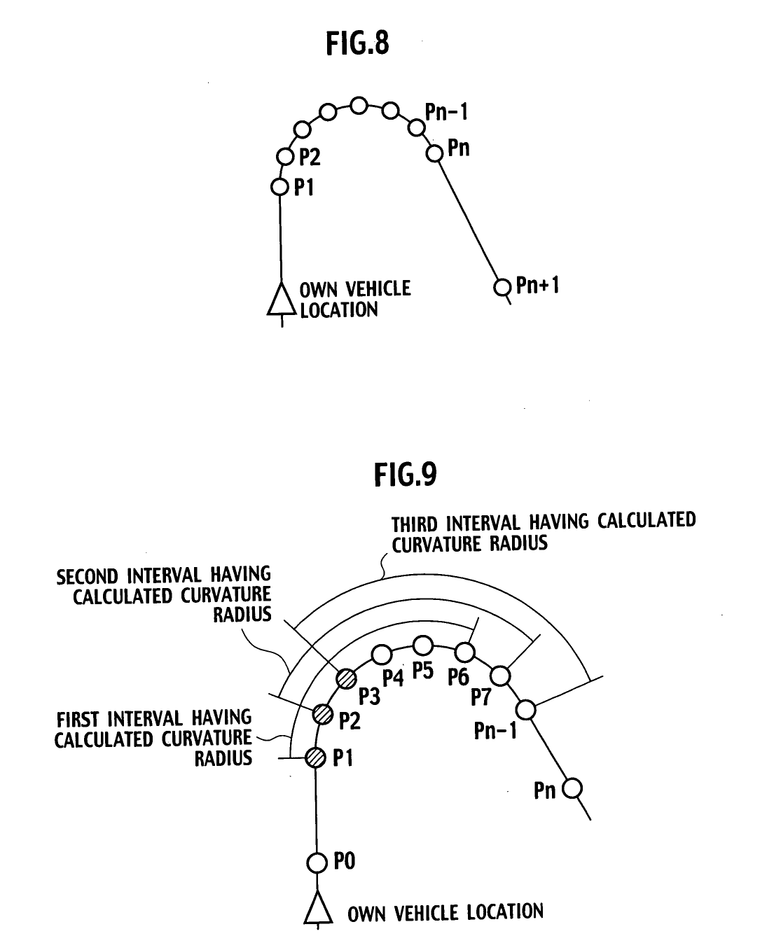

Next, at step S112, the curvature radius calculator 12 uses the point sequence data previewed by the road information previewer 11, to calculate a curvature radius of a curved interval of a travel path ahead of the own vehicle location. Concretely, when point sequence data as shown in FIG. 8 is previewed by the road information previewer 11, the curvature radius calculator 12 successively calculates a curvature radius concerning a point sequence between a point P₁ closest to the own vehicle location and a point Pₙ, just preceding to an end point of the previewed point sequence data. As a concrete method to calculate a curvature radius, it is conceivable to acquire a sum of link lengths and a sum of link angles within an interval as a target of curvature radius calculation, and to acquire a quotient as a curvature radius of the interval by dividing the sum of link lengths by the sum of link angles, for example.

Note that various methods for calculating curvature radii of curved intervals are utilizable, without limited to the above example. For example, it is possible to detect an interval, where a sum of link angles within a preset distance is equal to or greater than a preset value, as a curved interval, and to acquire a curvature radius of the curved interval (the details of which are described in Japanese Patent Application Laid-Open Publication No. 11-232599). Further, it is possible to use three points present ahead of a vehicle and to calculate a curvature radius of a curved interval represented by these three points based on distances between the first and second points and the second and third points of the point sequence as described in the Japanese Patent Application Laid-Open Publication No. 11-2528, or to utilize a spline function to interpolate coordinate values of four or more successive points to acquire a curvature radius as described in the Japanese Patent Application Laid-Open Publication No. 2000-321086.

Next, at step S113, the shape pattern decider 13 utilizes the point sequence data previewed by the road information previewer 11, to decide a shape pattern of the curved interval the curvature radius of which is calculated by the curvature radius calculator 12. Concretely, the shape pattern decider 13 decides whether or not the curved interval is applicable to the shape pattern requiring a curvature radius correction as shown in FIG. 3 or FIG. 4, by using the information on link lengths and link angles within the curved interval the curvature radius of which is calculated by the curvature radius calculator 12, as well as information on lengths of links preceding to and following the curved interval.

As a result of the decision at step S113, when it is decided that the shape of the curved interval the curvature radius of which is calculated by the curvature radius calculator 12, is applicable to the shape pattern requiring the curvature radius correction, the curvature radius corrector 14 subsequently sets a curvature radius correcting method at step S114, and corrects the curvature radius of the curved interval as calculated by the curvature radius calculator 12 based on the thus set correcting method at step S115.

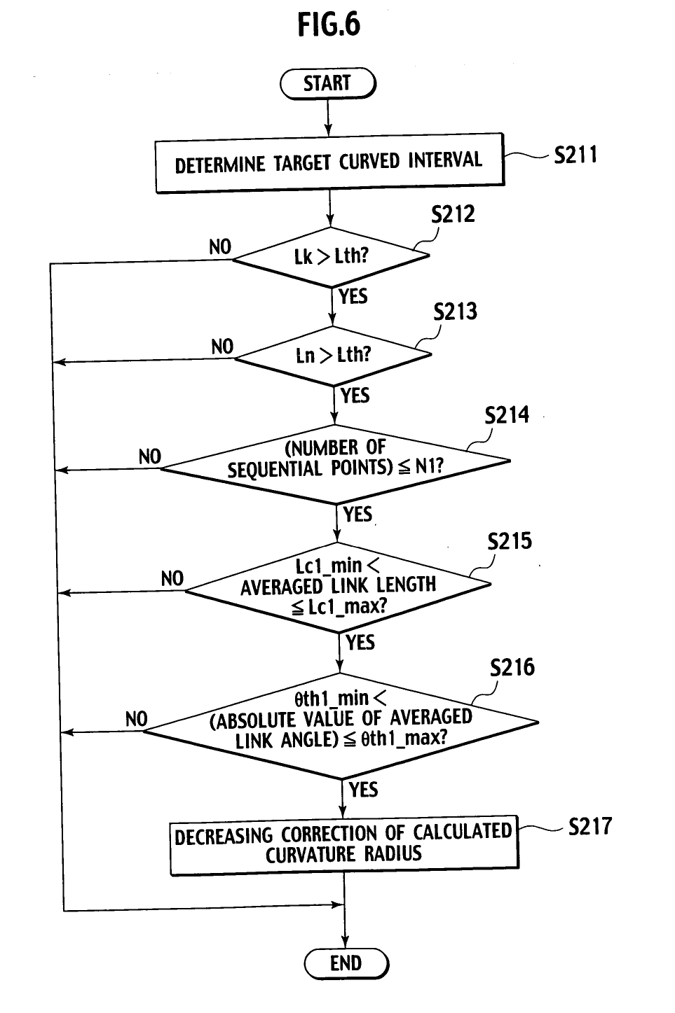

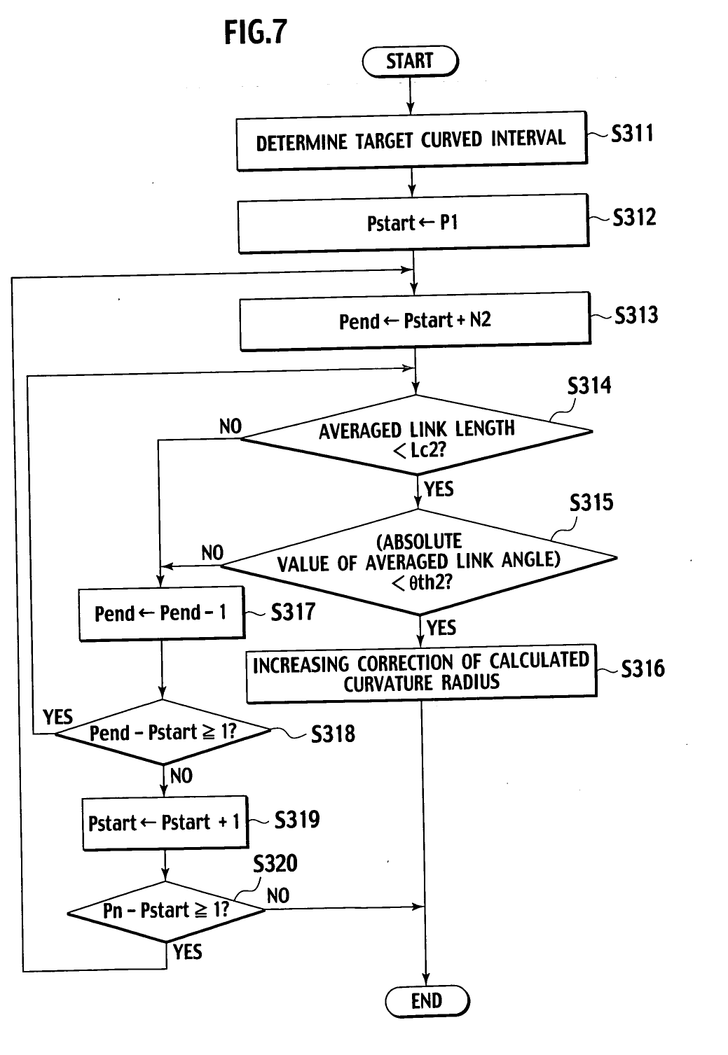

Details of the procedures from step S113 to step S115 for the shape pattern shown in FIG. 3 are different from those for the shape pattern shown in FIG. 4. There will be explained examples of procedures for the shape patterns shown in FIG. 3 and FIG. 4, based on flowcharts of FIG. 6 and FIG. 7, respectively.

In the procedure for the shape pattern shown in FIG. 3, there is firstly determined a curved interval as a shape pattern decision target, at step S211 of FIG. 6. Here, the curved interval as the shape pattern decision target is the interval the curvature radius of which is calculated by the curvature radius calculator 12 at step S112 of the flowchart of FIG. 5, and in the example of FIG. 8, the interval between the point P₁ and the point Pₙ is determined as a curved interval as a shape pattern decision target. Note that if intervals the curvature radii of which are calculated are successive or overlapping in the case of adopting methods for acquiring a curvature radius of an interval the sum of link angles of which within a preset distance is equal to or greater than a preset value, a curvature radius of an interval represented by three points present ahead of a vehicle, or a curvature radius of an interval of which coordinate values of four or more points are interpolated by a spline function; it is advisable to select a starting point of the interval closest to the own vehicle location among the successive or overlapping intervals as a starting point of a curved interval as a shape pattern decision target, and to select an ending point of the interval farthest from the own vehicle location as an ending point of the curved interval as the shape pattern decision target. Concretely, in a case where curvature radii are calculated for successive or overlapping first through third intervals as shown in FIG. 9, respectively, it is advisable to select a staring point P₁ of the first interval closest to the own vehicle location as a starting point of a shape pattern decision target, and to select an ending point Pₙ₋₁ of the third interval farthest from the own vehicle location as an ending point of the curved interval as the shape pattern decision target

At step S212 through step S216, it is decided whether or not the shape of the curved interval determined at step S211 is applicable to the shape pattern shown in FIG. 3, i.e., a short curved interval in a doglegged shape interposed between long straight intervals.

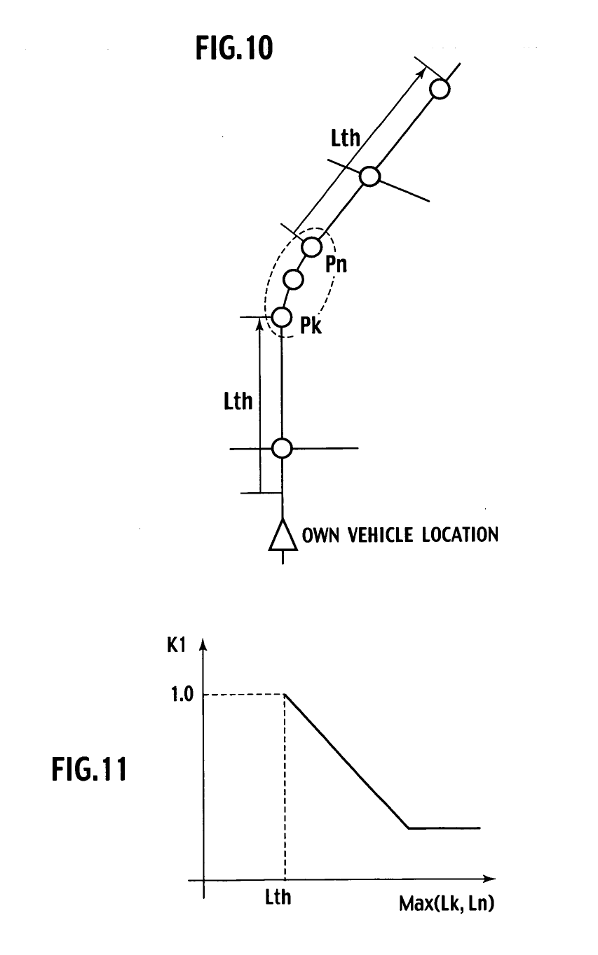

Namely, at step S212, it is decided whether or not a link length Lₖ just preceding to the curved interval determined at step S211 exceeds a preset threshold value Lₜₕ (50 m, for example). At step S213, it is decided whether or not a link length Lₙ just following the curved interval determined at step S211 exceeds the threshold value Lₜₕ. At step S212 and step S213, it is decided whether or not the curved interval determined at step S211 is an interval interposed between long straight intervals. Note that the decision of lengths of straight intervals just preceding to and following a curved interval may be conducted in a manner shown in FIG. 10, by deciding whether or not a sum of link angles of a point sequence present within the preset distance Lₜₕ (50 m, for example) preceding to the starting point Pₖ of the curved interval and a sum of link angles of a point sequence present within the preset distance Lₜₕ following the ending point Pₙ of the curved interval are each within a preset range (−5 degrees to +5 degrees, for example). In this case, it becomes possible to precisely decide presence/absence of a long straight interval, also dealing with even a situation where a point representing an intersection is present at a location substantially preceding to or following the curved interval.

Next, at step S214, it is decided whether or not the number of sequential points constituting the point sequence within the curved interval determined at step S211 is equal to or smaller than a threshold value N, (three, for example). Further, at step S215, it is decided whether or not an averaged link length of the curved interval determined at step S211 is within a range between a preset lower limit L_{c1}_{_{—}}ₘᵢₙ, (20 m, for example) and a preset upper limit L_{c1}_{_{—}}ₘₐₓ (40 m, for example). At step S216, it is decided whether or not an absolute value of an averaged link angle within the curved interval determined at step S211 is within a range between a preset lower limit θₜₕ₁_{_{—}}ₘᵢₙ(3 degrees, for example) and a preset upper limit θₜₕ₁_{_{—}}ₘₐₓ(5 degrees, for example). At step S214 through step S216, it is decided whether or not the curved interval determined at step S211 is a short interval having its point sequence including coarsely plotted points.

Thus, when the curved interval determined at step S211 meets all the conditions at step S212 through step S216, this curved interval is decided to be a short curved interval in a doglegged shape interposed between long straight intervals as shown in FIG. 3, and to be applicable to a shape pattern requiring correction for the curvature radius calculated by the curvature radius calculator 12 at step S112 in the flowchart of FIG. 5.

When the curved interval determined at step S211 meets all the conditions at step S212 through step S216, the calculated curvature radius R₁ of this curved interval is decreasedly corrected at step S217 by using the following equation (2), for example:
R₁′=K₁×R₁(K₁<1.0) (2)

Note that although the proportional constant K₁ in the equation (2) may be fixed at a constant value (0.7, for example), it becomes possible to correct a calculated curvature radius of a curved interval to a value approximating an actual road shape by setting the proportional constant by using a monotone decreasing function commensurately with a maximum value of lengths of straight intervals preceding to and following a curved interval, as shown in FIG. 11, for example.

According to the above procedures to be conducted by the curvature radius estimating apparatus of this embodiment, it is decided whether or not the shape of the curved interval the curvature radius of which is calculated by the curvature radius calculator 12 is a short curved interval in a doglegged shape interposed between long straight intervals, and when the shape is decided to be applicable to such a shape pattern, the curvature radius calculated by the curvature radius calculator 12 is corrected to a smaller value to allow for improvement of precision in estimation of a curvature radius of a curved interval of a travel path of own vehicle.

There will be explained the example of the procedure for the shape pattern shown in FIG. 4, based on the flowchart of FIG. 7. Note that this procedure is performed only when the point sequence of the curved interval the curvature radius of which is calculated by the curvature radius calculator 12, is defined with three or more points.

At step S311, there is determined a curved interval as a shape pattern decision target, identically to step S211 in the flowchart of FIG. 6. Next, there is conducted processing at steps S312, S313, and S317 through S320, for setting a portion (target portion) where points of the point sequence within the curved interval determined at step S311 are densely plotted. Further, at step S314 and step S315, it is decided whether or not the thus selected target portion is a portion within a curved interval which is applicable to the shape pattern shown in FIG. 4.

Concretely, at step S312, there is initially selected a starting point Pₛₜₐᵣₜ of the target portion within the curved interval. In case of the example shown in FIG. 4, the point P₁ which is a stating point of the curved interval is selected as the starting point Pₛₜₐᵣₜ of the target portion, for example. Next, at step S313, that point which is located forwardly of the starting point P_{end} of the target portion by a preset value N₂ (three, for example), is selected as an ending point P_{end} of the target portion. At this time, if the point which is to be located forward of the starting point Pₛₜₐᵣₜ of the target portion by the preset value N₂ is located forwardly beyond the ending point (the point Pₙ in the example shown in FIG. 4) of the curved interval, the ending point of the curved interval is selected as the ending point P_{end} of the target portion.

When the selected target portion does not meet the condition at step S314 or step S315, there is again conducted processing for setting a next target portion at step S317 through step S320. Concretely, the ending point P_{end} of the target portion is shifted to a point just preceding thereto at step S317, and it is decided at step S318 whether or not the point sequence between the starting point Pₛₜₐᵣₜ and the shiftedly acquired ending point P_{end} includes two or more sequential points.

When the number of sequential points included in the point sequence between the starting point Pₛₜₐᵣₜ and the shifted ending point P_{end} is two or more as a result of the decision at step S318, this portion is selected as a new target portion, and it is decided whether or not this target portion meets the conditions at step S314 and step S315. In turn, when the number of sequential points included in the point sequence between the starting point Pₛₜₐᵣₜ and shifted ending point P_{end} becomes one, the starting point Pₛₜₐᵣₜ of the target portion is shifted to a point just following it, at step S319. Further, at step S320, it is decided whether or not the point sequence between the shifted starting point Pₛₜₐᵣₜ and the ending point (point Pₙ in the example shown in FIG. 4) of the curved interval includes two or more sequential points.

When the number of sequential points included in the point sequence between the shifted starting point Pₛₜₐᵣₜ and the ending point of the curved interval is two or more as a result of the decision at step S320, the flow returns to step S313 to conduct setting of the ending point P_{end}. In turn, when the number of sequential points included in the point sequence between the shifted starting point Pₛₜₐᵣₜ and the ending point P_{end} of the curved interval becomes one, it is decided that any target portion applicable to the shape pattern shown in FIG. 4 is absent within this curved interval, and the procedure is terminated.

At step S314 and step S315, it is decided whether or not the shape of the selected target portion is applicable to the shape pattern shown in FIG. 4, i.e., is an interval where sequential points included in a point sequence are densely plotted within a curved interval having a large curvature radius.

Concretely, at step S314, it is decided whether or not an averaged link length of the selected target portion is less than a preset threshold value L_{c2} (20 m, for example). Next, it is decided whether or not an averaged link angle in the selected target portion is smaller than a preset threshold value θₜₕ₂ (5 degrees, for example) at step S315. When the conditions at both step S314 and step S315 are met, the target portion selected within the curved interval is decided to be an interval where sequential points included in a point sequence are densely plotted within a curved interval having a large curvature radius, like a portion encircled by a broken line in FIG. 4.

Thus, when the target portion meets the conditions at both step S314 and step S315, the curved interval determined at step S311 is decided to be a larger curved interval including a point sequence portion where sequential points are densely plotted as shown in FIG. 4, and to be applicable to a shape pattern requiring correction for the curvature radius calculated by the curvature radius calculator 12 at step S112 in the flowchart of FIG. 5.

When the target portion selected within the curved interval meets the conditions at both step S314 and step S315, the calculated curvature radius R₂ of this curved interval is increasedly corrected at step S316 by using the following equation (3), for example:
R₂′=K₂×R₂(K₂>1.0) (3)

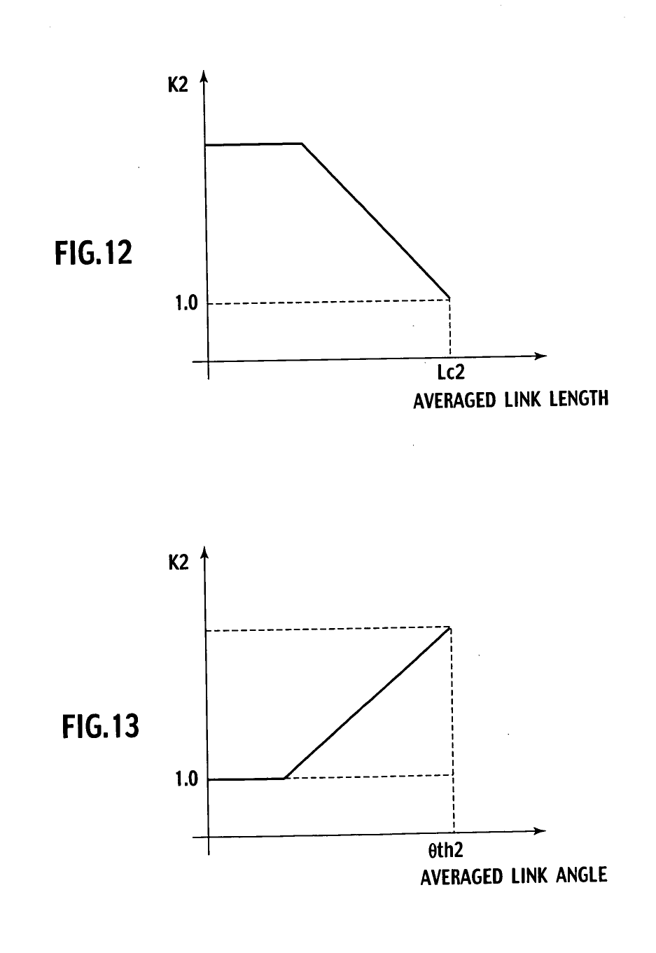

Note that although the proportional constant K₂ in the above equation (3) may be fixed at a constant value (1.5, for example), it becomes possible to correct a calculated curvature radius of a curved interval to a value approximating an actual road shape by setting the proportional constant, by using a monotone decreasing function as shown in FIG. 12 commensurately with an averaged link length of the above-mentioned target portion within the curved interval, or by using a monotone increasing function shown in FIG. 13 commensurately with an averaged link angle of the above-mentioned target portion within the curved interval, for example.

According to the above procedures to be conducted by the curvature radius estimating apparatus of this embodiment, it is decided whether or not the shape of the curved interval the curvature radius of which is calculated by the curvature radius calculator 12 is a larger curved interval including a point sequence portion where sequential points are densely plotted, and when the shape is decided to be applicable to such a shape pattern, the curvature radius calculated by the curvature radius calculator 12 is corrected to a larger value to allow for improvement of precision in estimation of a curvature radius of a curved interval of a travel path of own vehicle.

According to the curvature radius estimating apparatus of this embodiment as described above, it is decided by the shape pattern decider 13 whether or not the curved interval the curvature radius of which is calculated by the curvature radius calculator 12, is applicable to a shape pattern requiring correction for the calculated curvature radius, and when it is decided that the shape of the curved interval is applicable to the shape pattern requiring correction for the calculated curvature radius, the curvature radius calculated by the curvature radius calculator 12 is corrected by the curvature radius corrector 14. Thus, it becomes possible to estimate a curvature radius of a curved interval with good precision by using point sequence data included in map information even when the curved interval is in a shape pattern accompanied by a large variance of sequential points included in the point sequence data

Namely, according to the present invention, there is corrected a calculated curvature radius of a curved interval of a vehicle travel path as required commensurately with a shape pattern of the curved interval, thereby enabling estimation of the curvature radius of the curved interval with good precision even for a curved interval in a shape pattern accompanied by a large variance of sequential points included in point sequence data therefor.

(Second Embodiment)

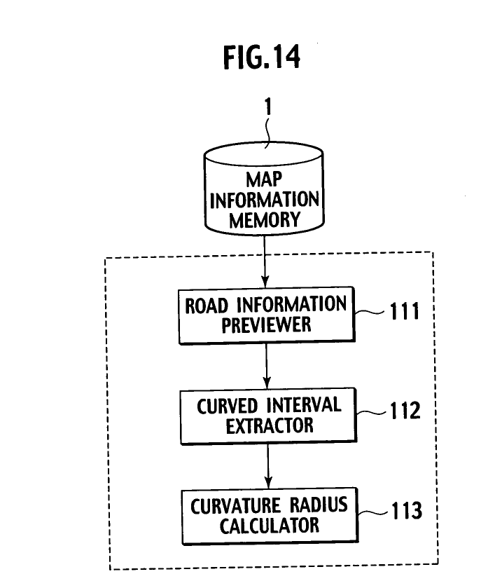

FIG. 14 is a functional block diagram of an outline of a curvature radius estimating apparatus according to a second embodiment of the present invention realized by the road information acquirer 5 of the vehicle-mounted navigation system. As shown in FIG. 14, the curvature radius estimating apparatus of this embodiment includes the road information previewer 11, a curved interval extractor 112, and a curvature radius calculator 113.

The road information previewer 11 is configured to acquire, from the map information memory 1, point sequence data included in map information around an own vehicle location, and to expand this point sequence data.

The curved interval extractor 112 is configured to use the point sequence data around the own vehicle location as expanded by the road information previewer 11, to extract a curved interval on a travel path of own vehicle.

The curvature radius calculator 113 is configured to use point sequence data within the curved interval on the travel path of own vehicle extracted by the curved interval extractor 112, to acquire a curvature radius of the curved interval.

The curvature radius estimating apparatus of this embodiment is configured to estimate a curvature radius of a curved interval of a travel path of own vehicle, based on the above processing in the functional components. Further, the information on curvature radii estimated by the curvature radius estimating apparatus are also handled by the road information acquirer 5 of the vehicle-mounted navigation system as information useful for own vehicle driving, and are exemplarily utilized so as to be displayed on a navigation screen to assist a driver in a driving operation, and to automatically control a vehicle behavior.

There will be now briefly explained an outline of processing in the curved interval extractor 112 which is characteristic of the curvature radius estimating apparatus of this embodiment as described above.

Because map information to be handled in a current vehicle-mounted navigation system is basically prepared as data for map display, point sequence data of the map information is not provided in a structure where points included in a point sequence representing a road shape are plotted in accordance with a preset rule. Nonetheless, talking notice of a relationship between a link length representing a spacing between adjacent two nodes (i.e., length of link connecting two nodes), a link angle representing an angle defined by adjacent two links (i.e., angle defined by an extension line of a preceding link and a succeeding link), and a road shape, there is a tendency that curved intervals having smaller curvature radii include shorter link lengths and larger link angles, respectively. Thus, in the curvature radius estimating apparatus of this embodiment, the curved interval extractor 112 is configured to select a preset interval of a travel path of own vehicle as a curve extraction target interval (target interval), and to extract, as a curved interval from the curve extraction target interval, an interval where preset conditions are met by an averaged link length, a maximum or minimum value of link lengths, and an averaged link angle, thereby enabling extraction of a curved interval with high precision.

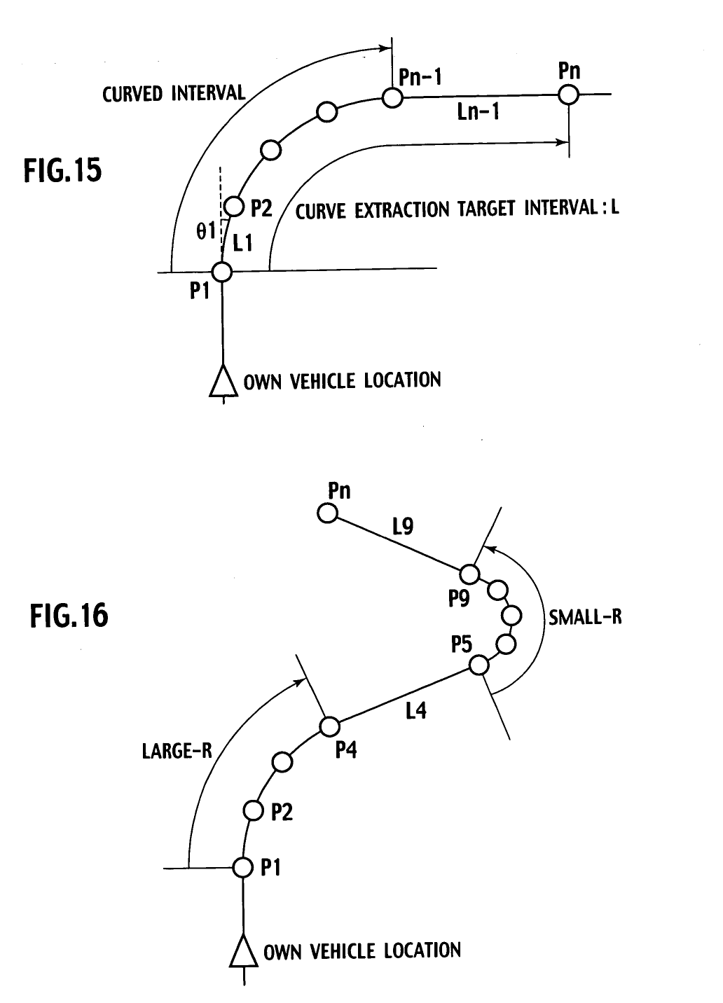

Concretely, for extraction of a curved interval having a point P₁ as a starting point in FIG. 15, there is selected, as a curve extraction target interval, an interval (P₁ to Pₙ) defined with sequential points constituting a point sequence present within a range of preset distance L from the starting point P₁, and it is firstly decided whether or not an averaged value of link lengths (L₁, . . . in FIG. 15), a maximum or minimum value of link lengths, and an averaged value of link angles (θ₁, . . . in FIG. 15) within the longest interval (P₁ to Pₙ) of the curve extraction target interval, meet preset conditions. Further, the ending point of the interval is sequentially shifted one by one toward the own vehicle location on the point sequence until the preset conditions are met, and an interval brought to meet the preset conditions is extracted as a curved interval. In turn, when the number of sequential nodes within the curve extraction target interval is brought to be two or less without meeting the preset conditions, it is decided that this curve extraction target interval includes no curved intervals. In the example shown in FIG. 15, the interval from P₁ to Pₙ₋₁ is to be extracted as a curved interval.

Note that the above-mentioned extraction of curved interval is desirably conducted for each of curvature radius levels of curved intervals (i.e., dimensions of curvature radii of curved intervals) as extraction targets. For example, it becomes possible to conduct extraction of curved intervals with good precision, by dividing curvature radius levels of curved intervals as extraction targets into three levels of small-R (less than 100R), medium-R (100R to 300R), and large-R (300R to 500R), and by conducting curved interval extraction decision in an order of small-R, medium-R, and large-R for a curve extraction target interval. In this case, if the point sequence data of a travel path of own vehicle is previewed as shown in FIG. 16, for example, intervals from P₁ to P₄ and from P₅ to P₉ are extracted as a large-R curved interval and a small-R curved interval, respectively.

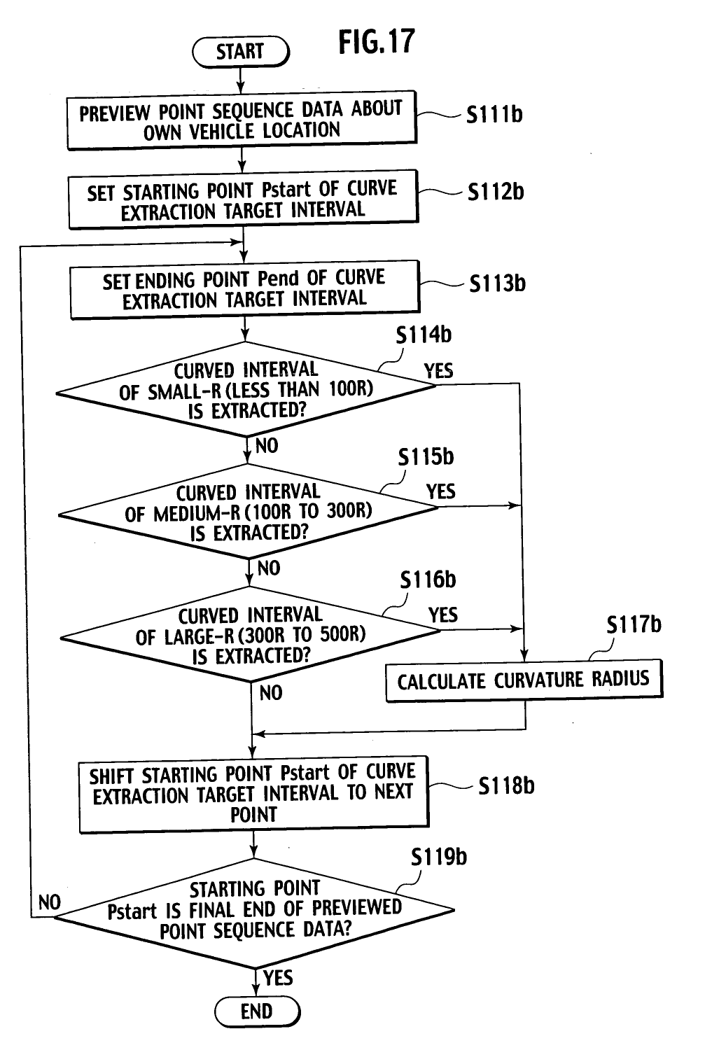

There will be explained an example of control procedures in the curvature radius estimating apparatus of this embodiment, with reference to flowcharts of FIG. 17 through FIG. 21. Note that the control procedures are invoked from a main program of the vehicle-mounted navigation system and repeatedly executed, at constant time intervals (such as 100 ms).

Firstly, the control procedure for the whole curvature radius estimating apparatus of this embodiment will be explained along the flowchart of FIG. 17.

At step S111b, the road information previewer 11 acquires point sequence data around an own vehicle location from the map information memory 1 of the vehicle-mounted navigation system, and previews the acquired point sequence data.

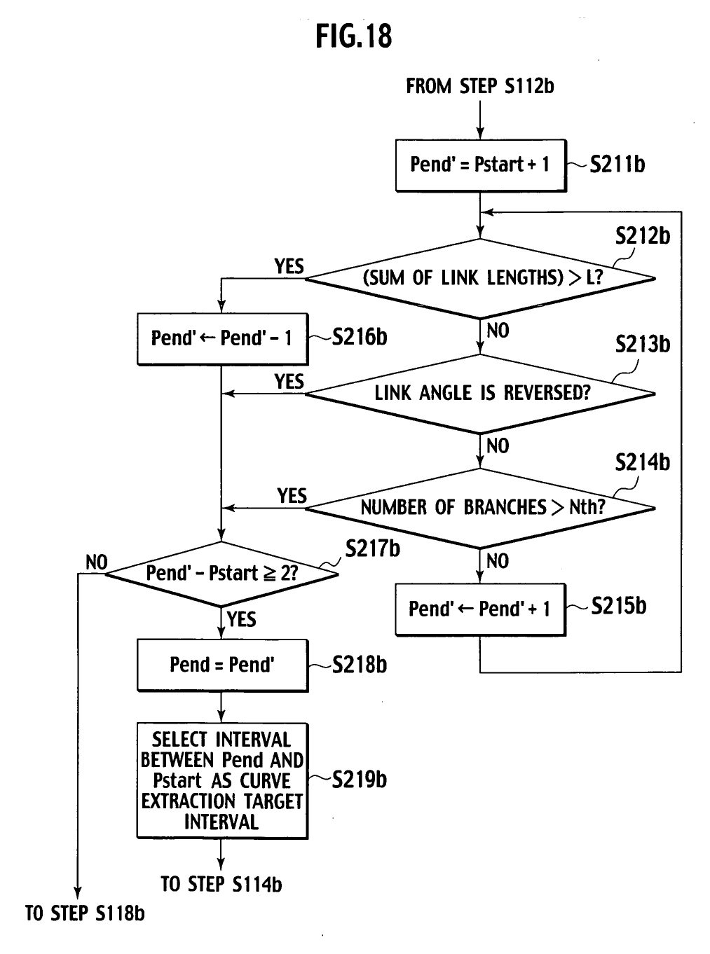

Next, at step S112b, the curved interval extractor 112 uses the point sequence data previewed by the road information previewer 11, to select a point (P₁ in the example shown in FIG. 15) closest to an own vehicle location on the travel path of own vehicle as a starting point Pₛₜₐᵣₜ for an initial curve extraction target interval. Further, at step S113b, there is selected an ending point P_{end} for the curve extraction target interval, to establish an interval between the starting point Pₛₜₐᵣₜ and ending point P_{end} as the curve extraction target interval. Note that details of the processing for selecting the ending point P_{end} for the curve extraction target interval at step S113b will be described later with reference to FIG. 18.

Next, at step S114b, there is extracted a small-R curved interval having a curvature radius less than about 100R within the established curve extraction target interval. When a small-R curved interval is extracted, the flow advances to step S117b. In turn, when a small-R curved interval is not extracted, there is conducted extraction of a medium-R curved interval having a curvature radius of about 100R to 300R at next step S115b, and the flow advances to step S117b when a medium-R curved interval is extracted. Further, when a medium-R curved interval is not extracted, there is conducted extraction of a large-R curved interval having a curvature radius of about 300R to 500R at next step S116b. The flow advances to step S117b when a large-R curved interval is extracted, and the flow advances to step S118b when no large-R curved intervals are extracted.

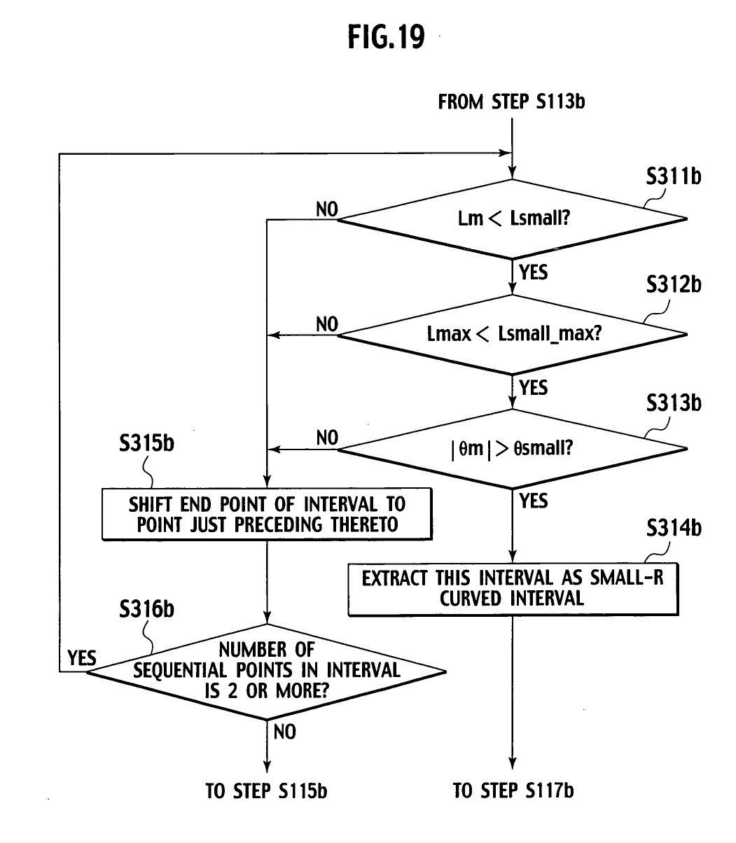

In the curvature radius estimating apparatus of this embodiment as described above, the curved interval extractor 112 is configured to extract curved intervals for each of curvature radius levels of curved intervals (i.e., dimensions of curvature radii of curved intervals) as extraction targets, in a manner to extract curved intervals in an order of small-R, medium-R, and large-R curved intervals, where the small-R curved interval has a smaller curvature radius which is highly required for indication of information, control of vehicle behavior, and the like. Note that details of processing for extracting curved intervals at step S114b through step S116b will be described later with reference to FIGS. 19 through 21.

At step S117b, the curvature radius calculator 113 uses the point sequence data within the curved interval extracted at any one of step S114b through step S116b, to calculate a curvature radius of the curved interval. Concretely, there is calculated a curvature radius R of the extracted curved interval by using link lengths and link angles of the links within the curved interval, based on the following equation (4), in which LS represents a sum (L₁+ . . . +Lₙ₋₂, in the example shown in FIG. 15) of link lengths (in meter) within the extracted curved interval, and θS represents a sum (θ₁+ . . . +θₙ₋₂, in the example shown in FIG. 15) of link angles (in radian) within the extracted curved interval:
R=LS/θS (4)

At step S118b, the curved interval extractor 112 shifts the starting point Pₛₜₐᵣₜ of the curve extraction target interval to a next point. As a method for shifting the starting point Pₛₜₐᵣₜ where the curved interval (P₁ to P₄, or P₅ to P₉) has its ending point delimited by a straight interval as in the example shown in FIG. 16, it is possible to shift the starting point to the end point of the curved interval, i.e., to P₄ directly after P₁, or to P₉ directly after P₅. Further, also in the case that a turning direction of own vehicle is changed in an S-shaped curved interval or a curved interval is delimited by other factors such as an intersection, it is possible to select the end point of the curved interval as a starting point Pₛₜₐᵣₜ of a next curve extraction target interval.

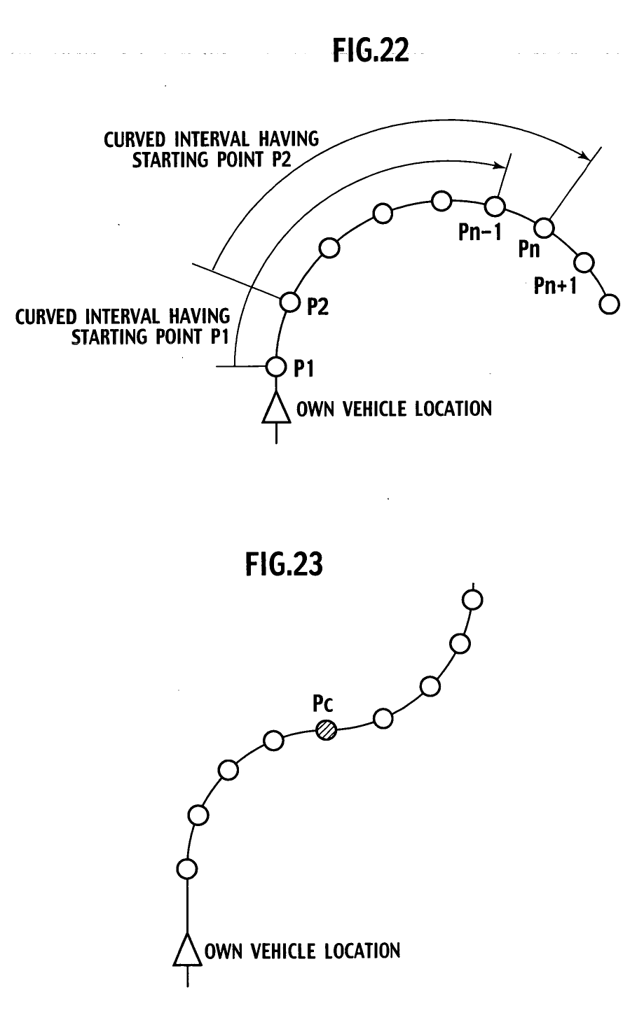

Meanwhile, as shown in FIG. 22, it is also conceivable that an ending point of a curve extraction target interval having a starting point P₁ is set at a point Pₙ₋₁ in case of curved interval extraction for a long curved interval because the curve extraction target interval exceeds an upper limit distance L when a point Pₙ is selected as the ending point, such that the curved interval to be extracted directly corresponds to the curve extraction target interval P₁ to Pₙ₋₁. In this way, when an end point of a curved interval is restricted by an upper limit distance of a curve extraction target interval, the next point (P₂ in the example shown in FIG. 22) is selected as a starting point Pₛₜₐᵣₜ of a next curve extraction target interval.

At step S119, after selecting the starting point Pₛₜₐᵣₜ of the next curve extraction target interval at step S118b, it is decided whether or not the starting point Pₛₜₐᵣₜ selected at step S118b is a final end (the farthest point from an own vehicle location on the travel path of own vehicle, and this is a point Pₙ in the example shown in FIG. 16) of the point sequence data previewed by the road information previewer 11 at step S111b. When the starting point Pₛₜₐᵣₜ selected at step S118b is not the final end of the previewed point sequence data, the flow returns to step S113b to repeat the processing thereat and onward. At the time where the starting point Pₛₜₐᵣₜ selected at step S118b coincides with the final end of the previewed point sequence data, the successive control flow is terminated.

Next, there will be explained details of processing for selecting an ending point P_{end} of a curve extraction target interval at step S113b of the flowchart shown in FIG. 17, with reference to FIG. 18.

In selecting the ending point P_{end}, firstly at step S211b, the point next to the starting point Pₛₜₐᵣₜ selected at step S112b or step S118b in FIG. 17 is selected as an ending point candidate P_{end}′ of the curve extraction target interval. Then, at step S212b, there is acquired a sum of link lengths within the interval from the starting point Pₛₜₐᵣₜ to the ending point candidate P_{end}′, and it is decided whether or not the sum exceeds the upper limit distance L. As a result, the flow advances to step S216b when the sum of link lengths within the interval from the starting point Pₛₜₐᵣₜ to the ending point candidate P_{end}′ exceeds the upper limit distance L, and to step S213b otherwise.

It is desirable here to set the upper limit distance L to be used for the decision, commensurately with each of curvature radius levels of curved intervals (i.e., dimensions of curvature radii of curved intervals) as extraction targets. Concretely, the upper limit distance L is set at 100 m for extraction of a small-R curved interval, and at 200 m for extraction of a medium-R curved interval and a large-R curved interval.

At step S213b, it is decided whether or not a sign of a link angle at the ending point candidate P_{end}′ is different from a sign of a link angle at a point just preceding thereto. As a result, when the sign of the link angle at the ending point candidate P_{end}′ is different from the sign of the link angle at the point just preceding thereto, it is decided that the ending point candidate P_{end}′ is a turning direction changing point P_{c} in an S-shaped curved interval such as shown in FIG. 23, so that the flow advances to step S217b. Contrary, when the sign of the link angle at the ending point candidate P_{end}′ is the same as the sign of the link angle at the point just preceding thereto, the flow advances to next step S214b.

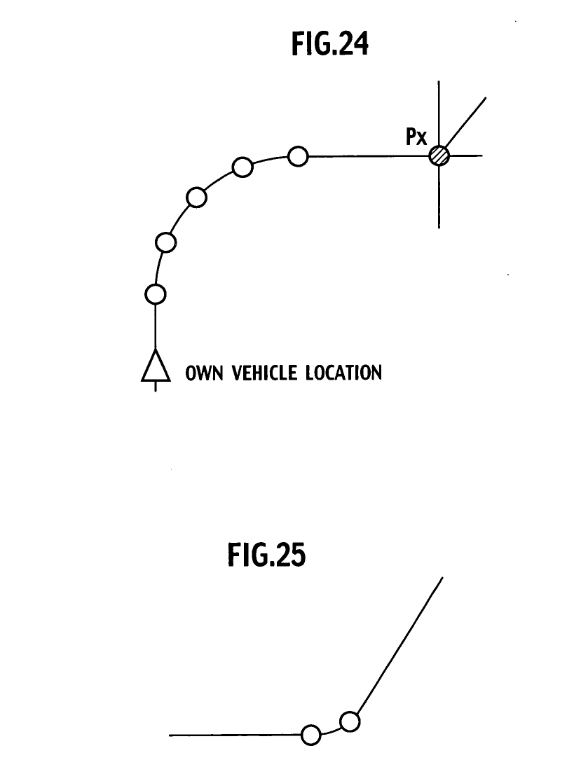

At step S214b, it is decided whether or not the number of branches at the ending point candidate P_{end}′ is larger than a preset value Nₜₕ (three, for example). As a result, when the number of branches at the ending point candidate P_{end}′ is larger than the preset value, it is decided that the ending point candidate P_{end}′ is an intersection Px in a complicated shape of five-forked road such as shown in FIG. 24, so that the flow advances to step S217b. Contrary, when the number of branches at the ending point candidate P_{end}′ is smaller than the preset value, the flow advances to step S215b.

At step S215b, the ending point candidate P_{end}′ is shifted to a next point, and then the flow returns to step S212b. Further, the ending point candidate P_{end}′ is sequentially shifted to a location apart from the starting point Pₛₜₐᵣₜ, until decision of “YES” in any one of step S212b through step S214b.

At step S216b where it has been decided at step S212b that the sum of link lengths within the interval from the starting point Pstart to ending point candidate P_{end}′ exceeds the preset upper limit distance L, the ending point candidate P_{end}′ is shifted to the point just preceding thereto and the flow advances to step S217b.

At step S217b, it is decided whether or not the number of sequential points (nodes) within the interval from the starting point Pₛₜₐᵣₜ to ending point candidate P_{end}′, is two or more. As a result, when the number of sequential points within the interval from the stating point Pₛₜₐᵣₜ to ending point candidate P_{end}′ is two or more, the ending point candidate P_{end}′ is selected as an ending point P_{end} of the curve extraction target interval at next step S218b. Further, at step S219b, the interval between the starting point Pₛₜₐᵣₜ and ending point P_{end} is selected as the curve extraction target interval, and the flow advances to step S114b in FIG. 17.

In turn, when the number of sequential points within the interval between the starting point Pₛₜₐᵣₜ and ending point candidate P_{end}′ is smaller than two as a result of decision at step S217b, the flow transfers to step S118b of the flowchart in FIG. 17, to shift the starting point Pₛₜₐᵣₜ of the curve extraction target interval to a next point.

Next, there win be explained details of processing for extracting a small-R curved interval at step S114b of the flowchart in FIG. 17, with reference to FIG. 19.

In extraction of a small-R curved interval, firstly at step S311b, there is acquired an averaged value Lₘ of link lengths within the curve extraction target interval, and it is decided whether or not this averaged link length Lₘ is less than a threshold value Lₛₘₐₗₗ (20 m, for example). As a result, the flow advances to step S315b when the averaged link length Lₘ of the curve extraction target interval is equal to or greater than the threshold value Lₛₘₐₗₗ, and to next step S312b when less than the threshold value Lₛₘₐₗₗ.

At step S312b, there is acquired a maximum link length Lₘₐₓ within the curve extraction target interval, and it is decided whether or not this maximum link length Lₘₐₓ is less than a threshold value Lₛₘₐₗₗ_{_{—}}ₘₐₓ (30 m, for example). As a result, the flow advances to step S315 when the maximum link length Lₘₐₓ within the curve extraction target interval is equal to or greater than the threshold value Lₛₘₐₗₗ_{_{—}}ₘₐₓ, and to next step S313b when less than the threshold value Lₛₘₐₗₗ_{_{—}}ₘₐₓ.

At step S313b, there is acquired an averaged value θm of link angles within the curve extraction target interval, and it is decided whether or not an absolute value |θm| of the averaged link angle exceeds a threshold value θₛₘₐₗₗ (10 degrees, for example). As a result, the flow advances to step S315b when the absolute value |θm| of the averaged link angle within the curve extraction target interval is equal to or smaller than the threshold value θₛₘₐₗₗ, and to next step S314b when exceeding the threshold value θₛₘₐₗₗ.

When decision of “YES” is given at all step S311b through step S313b so that all the conditions at these step S311b through step S313b are met, the interval in question is extracted as a small-R curved interval at step S314b, and the flow advances to step S117b of the flowchart in FIG. 17.

In turn, when decision of “NO” is given at any one of step S311b through step S313b, the end point of the interval in question is shifted to a point just preceding thereto. Further, at step S316b, it is decided whether or not the number of sequential points (nodes) within the interval up to the end point selected at step S315b is two or more, and when the number of sequential points within the interval is two or more, the flow returns to step S311b to repeat decisions at step S311b through step S313b. In turn, when the number of sequential points within the interval is decreased to be less than two without meeting any one of the conditions at step S311b through step S313b, the flow transfers to step S115b of the flowchart in FIG. 17.

Concretely explaining a procedure for extracting a small-R curved interval, taking the point sequence data shown in FIG. 15 for example, there is firstly selected an interval P₁ to Pₙ as a curve extraction target interval, and decisions at step S311b through step S313b are conducted for this interval P₁ to Pₙ. As a result, since the maximum link length Lₘₐₓ (Lₙ₋₁ in this case) exceeds the threshold value Lₛₘₐₗₗ _{_{—}}ₘₐₓ (30 m, for example), the interval end point is shifted to a point Pₙ₋₁ just preceding thereto. Next, decisions at step S311b through step S313b are conducted for the interval P₁ to Pₙ₋₁. As a result, all the conditions are met in this example since the interval P₁ to Pₙ₋₁ is a small-R curved interval, so that this interval P₁ to Pₙ₋₁ is extracted as the small-R curved interval.

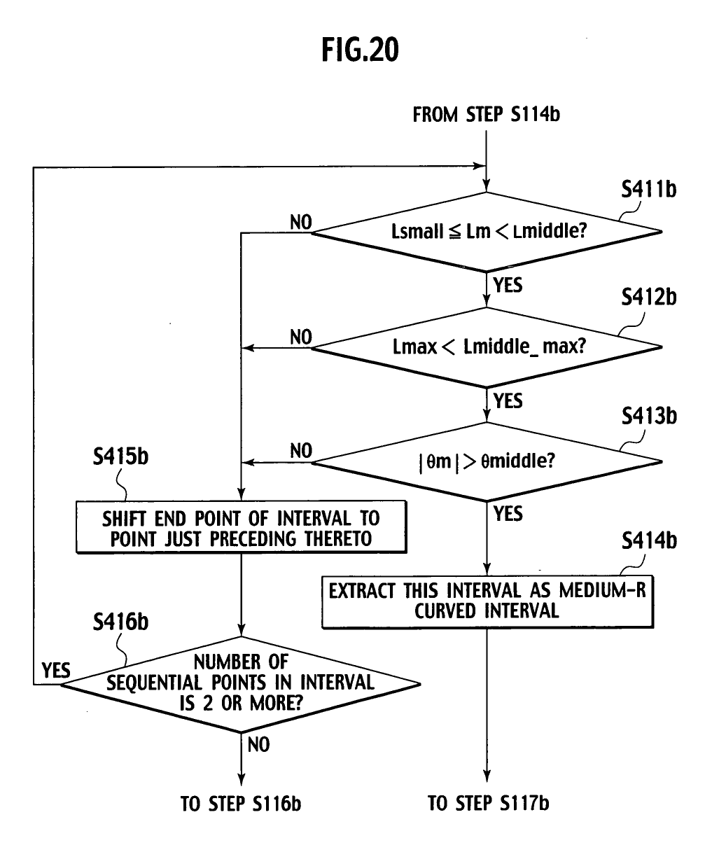

Next, there will be explained details of processing for extracting a medium-R curved interval at step S115b of the flowchart in FIG. 17, with reference to FIG. 20.

In extraction of a medium-R curved interval, firstly at step S411b, there is acquired an averaged value Lₘ of link lengths within the curve extraction target interval, and it is decided whether or not this averaged link length Lₘ is equal to or greater than the threshold value Lₛₘₐₗₗ (20 m, for example) and less than a threshold value L_{middle} (30 m, for example). As a result, the flow advances to step S415b when the averaged link length Lₘ of the curve extraction target interval is less than the threshold value Lₛₘₐₗₗ or equal to or greater than the threshold value L_{middle}, and to next step S412b when equal to or greater than the threshold value Lₛₘₐₗₗ and less than the threshold value L_{middle}.

At step S412b, there is acquired a maximum link length Lₘₐₓ within the curve extraction target interval, and it is decided whether or not this maximum link length Lₘₐₓ is less than a threshold value L_{middle}_{_{—}}ₘₐₓ (60m, for example). As a result, the flow advances to step S415 when the maximum link length Lₘₐₓ within the curve extraction target interval is equal to or greater than the threshold value L_{middle}_{_{—}}ₘₐₓ, and to next step S413b when less than the threshold value L_{middle}_{_{—}}ₘₐₓ.

At step S413b, there is acquired an averaged value θm of link angles within the curve extraction target interval, and it is decided whether or not an absolute value |θm| of the averaged link angle exceeds a threshold value θ_{middle} (5 degrees, for example). As a result, the flow advances to step S415b when the absolute value |θm| of the averaged link angle within the curve extraction target interval is equal to or smaller than the threshold value θ_{middle}, and to next step S414b when exceeding the threshold value θ_{middle}.

When decision of “YES” is given at all step S411b through step S413b so that all the conditions at these step S411b through step S413b are met, the interval in question is extracted as a medium-R curved interval at step S414b, and the flow advances to step S117b of the flowchart in FIG. 17.

In turn, when decision of “NO” is given at any one of step S411b through step S413b, the end point of the interval in question is shifted to a point just preceding thereto. Further, at step S416b, it is decided whether or not the number of sequential points (nodes) within the interval up to the end point selected at step S415b is two or more, and when the number of sequential points within the interval is two or more, the flow returns to step S411b to repeat decisions at step S411b through step S413b. In turn, when the number of sequential points within the interval is decreased to be less than two without meeting any one of the conditions at step S411b through step S413b, the flow transfers to step S116b of the flowchart in FIG. 17.

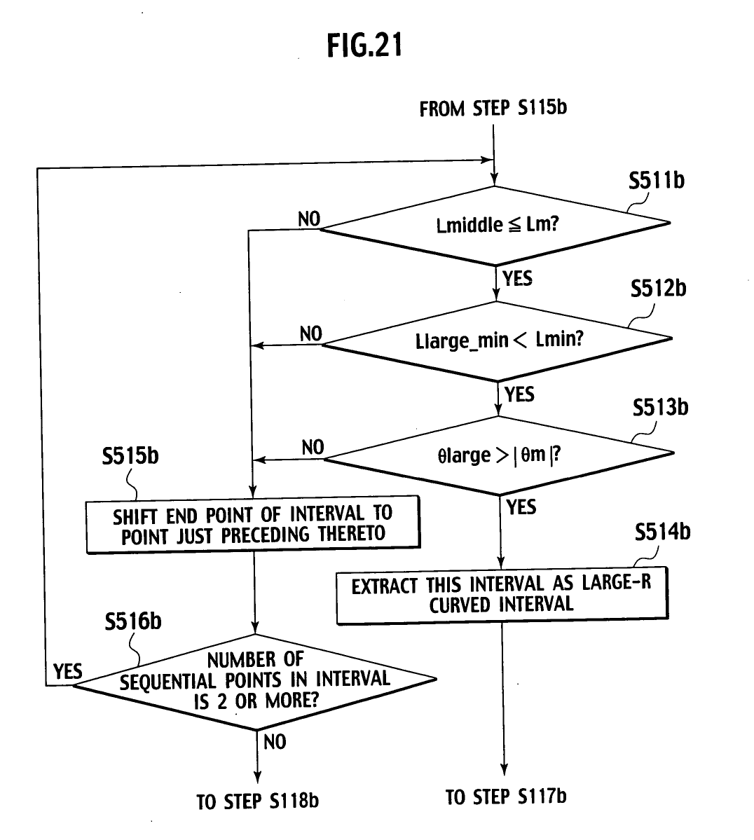

Next, there will be explained details of processing for extracting a large-R curved interval at step S116b of the flowchart in FIG. 17, with reference to FIG. 21.

In extraction of a large-R curved interval, firstly at step S511b, there is acquired an averaged value Lₘ of link lengths within the curve extraction target interval, and it is decided whether or not this averaged link length Lₘ is equal to or greater than the threshold value L_{large} (30 m, for example). As a result, the flow advances to step S515b when the averaged link length Lₘ of the curve extraction target interval is less than the threshold value L_{middle}, and to next step S512b when equal to or greater than the threshold value L_{middle}.

At step S512b, there is acquired a minimum link length Lₘᵢₙ within the curve extraction target interval, and it is decided whether or not this minimum link length Lₘᵢₙ exceeds a threshold value L_{large}_{_{—}}ₘᵢₙ (20 m, for example). As a result, the flow advances to step S515 when the minimum link length Lₘᵢₙ within the curve extraction target interval is equal to or smaller than the threshold value L_{large}_{_{—}}ₘᵢₙ, and to next step S513b when exceeding the threshold value

At step S513b, there is acquired an averaged value θm of link angles within the curve extraction target interval, and it is decided whether or not an absolute value |θm| of the averaged link angle is smaller than a threshold value θ_{large} (4.5 degrees, for example). As a result, the flow advances to step S515b when the absolute value |θm| of the averaged link angle within the curve extraction target interval is equal to or greater than the threshold value θ_{large}, and to next step S514b when less than the threshold value θ_{large}.

When decision of “YES” is given at all step S511b through step S513b so that all the conditions at these step S511b through step S513b are met, the interval in question is extracted as a large-R curved interval at step S514b, and the flow advances to step S117b of the flowchart in FIG. 17.

In turn, when decision of “NO” is given at any one of step S511b through step S513b, the end point of the interval in question is shifted to a point just preceding thereto. Further, at step S516b, it is decided whether or not the number of sequential points (nodes) within the interval up to the end point selected at step S515b is two or more, and when the number of sequential points within the interval is two or more, the flow returns to step S511b to repeat decisions at step S511b through step S513b. In turn, when the number of sequential points within the interval is decreased to be less than two without meeting any one of the conditions at step S511b through step S513b, the flow transfers to step S118b of the flow chart in FIG. 17.

In the curvature radius estimating apparatus of this embodiment as described above, the curved interval extractor 112 is configured to extract curved intervals for each of curvature radius levels of curved intervals (i.e., dimensions of curvature radii of curved intervals) as extraction targets, in a manner that extraction of curved interval depends on whether or not the preset conditions are met by an averaged link length Lₘ, a maximum link length Lₘₐₓ or minimum link length Lₘᵢₙ, and an averaged link angle θm of an interval in question. Further, the conditions for extraction of curved interval are selected commensurately with curvature radius levels as extraction targets, respectively.

Summarized in the following Table 1 are examples of curved interval extracting conditions to be selected for curvature radius levels of curved intervals as extraction targets, respectively:

TABLE 1

| Small-R | Medium-R | Large-R |
|---|---|---|
| (less than 100 R) | (100 R to 300 R) | (300 R to 500 R) |
| Lₘ < Lₛₘₐₗₗ | Lₛₘₐₗₗ ≦ Lₘ < L_{middle} | L_{middle} ≦ Lₘ |
| Lₘₐₓ < Lₛₘₐₗₗ_{—max} | Lₘₐₓ < L_{middle}_{—max} | L_{large}_{—min} < Lₘᵢₙ |
| θₘ > θₛₘₐₗₗ | θₘ > θ_{middle} | θ_{large} > θₘ |

Among the threshold values used in the curved interval extraction as described above, the threshold values (Lₛₘₐₗₗ, L_{middle}, Lₛₘₐₗₗ_{_{—}}ₘₐₓ, and L_{large}_{_{—}}ₘᵢₙ) relating to link lengths are determined commensurately with a plotting tendency of the point sequence data included in the map information stored in the map information memory 1. Note that these threshold values relating to link lengths may be varied correspondingly to a road type of a curve extraction target interval. Namely, spacings between sequential points of point sequence data tend to be plotted in a relatively longer manner in case of an express highway, so that the threshold values for the averaged link length Lₘ may be changed to be larger than those for an ordinary road such that Lₛₘₐₗₗ=30 m and L_{middle}=40 m, to facilitate extraction of curved intervals at an interchange or junction. Simultaneously therewith, it is also possible to change the threshold values (Lₛₘₐₗₗ_{_{—}}ₘₐₓ and L_{middle}_{_{—}}ₘₐₓ) for the maximum link length Lₘₐₓ and/or the threshold value (L_{large} _{_{—}}ₘᵢₙ) for the minimum link length Lₘᵢₙ.

Further, the threshold values relating to link lengths may be changed correspondingly to the number of sequential points constituting a point sequence within a curve extraction target interval. For example, since link lengths tend to become short in a point sequence defined with a small number of sequential points as shown in FIG. 25 in case of extracting a small-R curved interval, the threshold values (Lₛₘₐₗₗ and Lₛₘₐₗₗ_{_{—}}ₘₐₓ) relating to link lengths may be changed correspondingly to the number of sequential points constituting the point sequence, as follows. Simultaneously therewith, the threshold values relating to link angles may also be changed.

| Number of sequential points | | |
|---|---|---|
| constituting a point sequence | Lₛₘₐₗₗ | Lₛₘₐₗₗ_{—max} |
| 3 | 20 m | 20 m |
| 2 | 15 m | 20 m |

Moreover, among the threshold values to be used for curved interval extraction, the threshold values (θₛₘₐₗₗ, θ_{middle}, and θ_{large}) relating to link angles are determined commensurately with the threshold values relating to link lengths and with curvature radius levels of curved intervals. For example, in case of extracting a small-R curved interval, there is acquired a central angle of 11.5 degrees for a sector having an arc length equal to the threshold value Lₛₘₐₗₗ (20 m, for example) for the averaged link length Lₘ and having a radius equal to the maximum curvature radius (100 m) for a small-R curved interval, so that the threshold value θₛₘₐₗₗ for the averaged link angle θm is determined to be 10 degrees, for example, taking account of plotting variance of point sequence data. Similarly, the threshold value θ_{middle} for the averaged link angle θm in case of extracting a medium-R curved interval is determined to be 5 degrees, for example, and the threshold value θ_{large} for the averaged link angle θm in case of extracting a large-R curved interval is determined to be 4.5 degrees, for example.

According to the curvature radius estimating apparatus of this embodiment as described above, the curved interval extractor 112 is configured to select a preset interval of a travel path of own vehicle as a curve extraction target interval, and to extract, as a curved interval from the curve extraction target interval, an interval where preset conditions are met by an averaged link length, a maximum or minimum value of link lengths, and an averaged link angle, thereby enabling extraction of a curved interval with high precision even for a road shape accompanied by a large variance of sequential points included in point sequence data therefor. Further, the curvature radius calculator 113 is configured to acquire a curvature radius of the thus extracted curved interval by using the point sequence data within this curved interval, thereby enabling estimation of a curvature radius of a curved interval of a vehicle travel path with high precision without complicating the processing therefor, and enabling suitable indication of information, control of vehicle behavior, and the like without giving incongruent feeling to a driver.

(Third Embodiment)

There will be explained a third embodiment of the present invention. This embodiment is characterized by processing of the curved interval extractor 112 for selecting an ending point P_{end} of a curve extraction target interval. Namely, the second embodiment has been configured to select that point, when present, as an ending point P_{end} of a curve extraction target interval, which is located within a preset distance L from a starting point Pₛₜₐᵣₜ of the curve extraction target interval and which has a link angle sign different from that of a point just preceding thereto. However, the third embodiment is configured to treat three successive points (including first point, second point, and third point) within a preset distance L from a starting point Pₛₜₐᵣₜ of a curve extraction target interval, in a manner to select the second point as an ending point P_{end} of the curve extraction target interval when the first point has a link angle sign different from that of the second point, and the second point has the same link angle sign as that of the third point. Since the basic configuration and controlling outline of the curvature radius estimating apparatus of the third embodiment are the same as those of the second embodiment, only characteristic portions of the third embodiment will be described while omitting a redundant description of those portions thereof which are the same as the second embodiment.

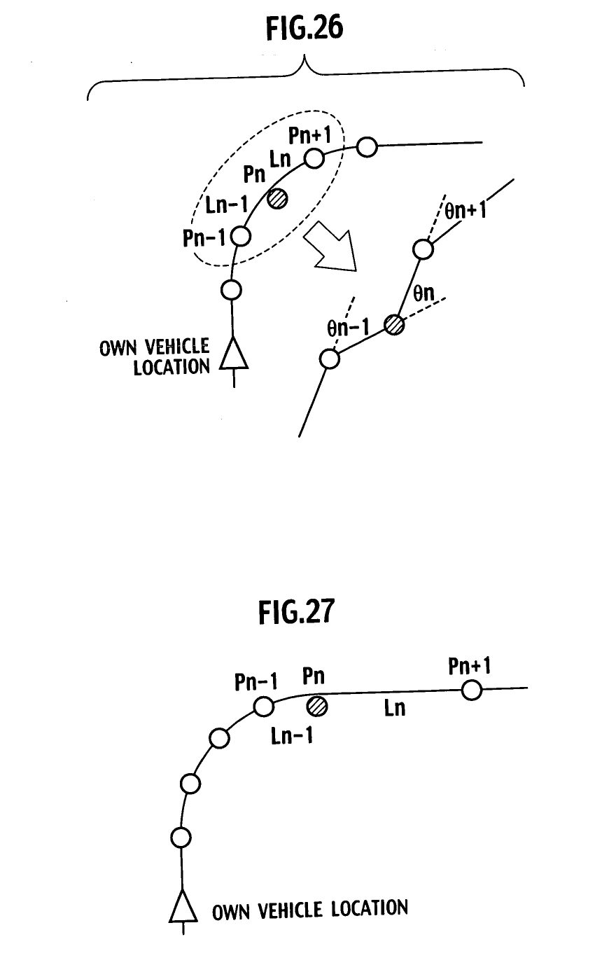

The third embodiment is configured to suitably set a curve extraction target interval even when a point sequence representing a travel path of own vehicle includes a point deviated from a center line of a road as shown in FIG. 26 and FIG. 27. Namely, it is probable that only one point of sequential points for a singular curved interval is plotted deviatedly from the curved interval toward its inside, such as a point Pₙ of point sequence data included in map information as shown in FIG. 26 and FIG. 27. In this case, the point Pₙ is differentiated from the turning direction changing point P_{c} of the S-shaped curved interval shown in FIG. 23, by utilizing a fact that the point Pₙ has a sign of its link angle θₙ different from those of the link angle θₙ₋₁ and link angle θₙ₊₁ of preceding point Pₙ₋₁ and following point Pₙ₊₁, respectively, so as not to select the point Pₙ as an ending point P_{end} of the curve extraction target interval.

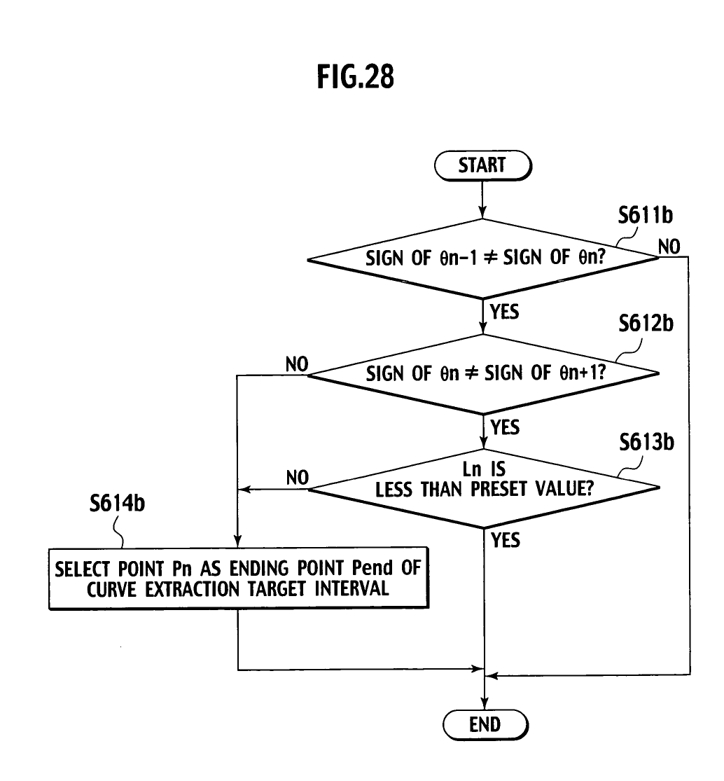

There will be explained an outline of processing which is characteristic of the curvature radius estimating apparatus of this embodiment, with reference to a flowchart of FIG. 28. Note that this processing is conducted instead of the procedure at step S213b of the flowchart in FIG. 18.

Assuming a point Pₙ to be an ending point candidate P_{end}′ of a curve extraction target interval, it is firstly decided at step S611b whether or not this point Pₙ has a sign of its link angle θₙ which is different from a sign of a link angle θₙ₋₁ at a point Pₙ₋₁ just preceding to the point Pₙ. When the sign of the link angle θₙ is different from that of the link angle θₙ₋₁, it is decided at next step S612b whether or not the sign of the link angle θₙ at this point Pₙ is different from a sign of a link angle θₙ₊₁ of a point Pₙ₊₁ just following the point Pₙ.

When decided to be “Yes” at step S611b and “No” at step S612b, it is decided that the point Pₙ is a turning direction changing point of an S-shaped curved interval such as shown in FIG. 23, so that the flow advances to step S614b. Contrary, when decided to be “Yes” at both step S611b and step S612b, it is decided that the point Pₙ is not a turning direction changing point of an S-shaped curved interval but a point which is included in sequential points constituting a point sequence of a singular curved interval of a road and which has a location deviated from a center line of the road, so that the flow advances to next step S613b.

At step S613b, to decide whether or not the point Pₙ is a point at an exit of a curved interval as shown in FIG. 27, it is decided whether or not a link length Lₙ, as a spacing between the point Pₙ and point Pₙ₊₁ is less than a preset value, i.e., whether or not the link length Lₙ is less than the threshold value (Lₛₘₐₗₗ_{_{—}}ₘₐₓ, L_{middle}_{_{—}}ₘₐₓ) for the maximum link length Lₘₐₓ to be used for curved interval extraction, for example. As a result, when the link length Lₙ is less than the preset value, it can be decided that the point Pₙ is not a turning direction changing point of an S-shaped curved interval nor a point at an exit of a curved interval, so that the flow transfers to the next procedure (step S214b in the flowchart of FIG. 18) without selecting this point Pₙ as an ending point P_{end} of the curve extraction target interval. Contrary, when the link length Lₙ is equal to or longer than the preset value, it is decided that the point Pₙ is located at an exit of a curved interval, so that the flow advances to step S614b.

At step S614b, the point Pₙ, is selected as an ending point P_{end} of the curve extraction target interval. By the above processing in this embodiment, it becomes possible to establish a curve extraction target interval having an ending point P_{end} which is a tuning direction changing point of an S-shaped curved interval or which is a point at an exit of a curved interval while avoiding affection due to variance of sequential points included in point sequence data therefor, thereby enabling extraction of a curved interval with high precision.

(Fourth Embodiment)

There will be explained a fourth embodiment of the present invention. This embodiment is characterized by a curved interval corrector configured to correct a curved interval extracted by the curved interval extractor 112. Since the basic configuration and controlling outline of the curvature radius estimating apparatus of the fourth embodiment are the same as those of the second and third embodiments, only characteristic portions of the fourth embodiment will be described while omitting a redundant description of those portions thereof which are the same as the second and third embodiments.

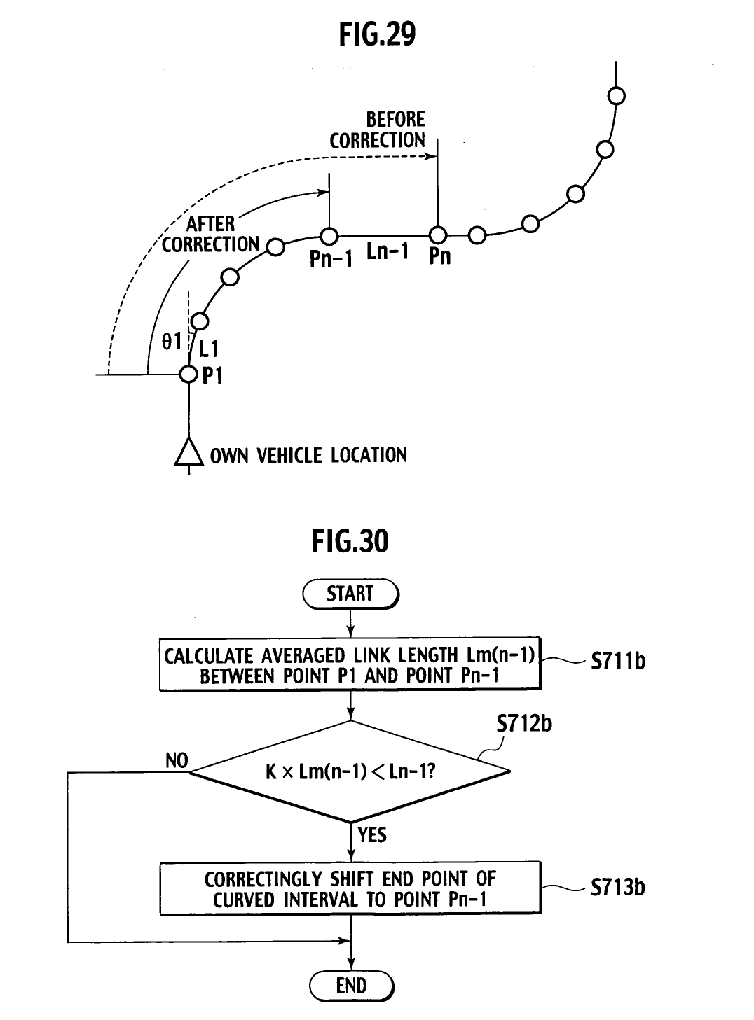

The fourth embodiment is configured to correct a curved interval extracted by the curved interval extractor 112 to enable extraction of a suitable curved interval without including a straight interval, in such an assumed situation of FIG. 29 where a straight interval having a short rectilinear distance between curved intervals such as in a winding mountain road is extracted as a part of the preceding one of the curved intervals.

Concretely, in the example shown in FIG. 29, although an interval between a point P₁ and a point Pₙ₋₁ is a single curved interval, the curved interval extractor 112 is brought to extract an interval between the point P₁ and a point Pₙ as a curved interval, when a link length Lₙ₋₁ between the point Pₙ₋₁ and the point Pₙ is less than the threshold value (Lₛₘₐₗₗ_{_{—}}ₘₐₓ, L_{middle}_{_{—}}ₘₐₓ) for the maximum link length Lₘₐₓ of the curved interval extracting condition. As such, this embodiment includes the curved interval corrector configured to acquire an averaged link length of an interval between the starting point (P₁) and a point (Pₙ₋₁) just preceding to the ending point (Pₙ) in a curved interval extracted by the curved interval extractor 112, and to correct the ending point of the curved interval extracted by the curved interval extractor 112 to the point Pₙ₋₁ just preceding thereto toward an own vehicle location when a link length Lₙ₋₁ for the point Pₙ₋₁ is longer than the averaged link length by a preset value or more. This allows the interval between the point P₁ and point Pₙ₋₁ to be precisely extracted as a curved interval, even in the example shown in FIG. 29.

There will be explained an outline of processing by the curved interval corrector which is characteristic of the curvature radius estimating apparatus of the fourth embodiment, with reference to a flowchart of FIG. 30. Note that this processing is executed as pre-processing for the procedure at step S117b in the flowchart of FIG. 17.

Assuming that an interval between the point P₁ and point Pₙ has been extracted by the curved interval extractor 112, the curved interval corrector is configured to acquire an averaged link length Lₘ₍ₙ₋₁₎ of an interval between the starting point P₁ and the point Pₙ₋₁ just preceding to the ending point Pₙ of the extracted curved interval, at step S711b. At step S712b, it is decided whether or not the link length Lₙ₋₁ for the point Pₙ₋₁ meets the condition of the following equation (5) for the averaged link length Lₘ₍ₙ₋₁₎ acquired at step S711b. Note that K is a constant in the equation (5), and has a value of 1 or more, and 1.5, for example:
K×Lₘ₍ₙ₋₁₎<Lₙ₋₁ (5)

For the decision at step S712b, it is also possible to adopt the condition of the following equation (6) instead of the equation (5). Note that reference character C in the equation (6) is a constant value, and 10 m, for example:
Lₘ₍ₙ₋₁₎+C<Lₙ₋₁ (6)

When the link length Lₙ₋₁ for the point Pₙ₋₁ is decided to meet the above condition as a result of decision at step S712b, the point Pₙ of the curved interval extracted by the curved interval extractor 112 is corrected to the point Pₙ₋₁ just preceding to the point Pₙ toward the own vehicle location, at step S713b. Contrary, when the link length Lₙ₋₁ for the point Pₙ₋₁ does not meet the condition, the processing is terminated without conducting correction of the curved interval. The above processing in this embodiment allows for extraction of a curved interval with high precision, even in a road situation including a short rectilinear distance between curved intervals.

Thus, according to the present invention, curved intervals are extracted depending on whether or not the preset conditions are met by an averaged link length, a maximum link length or minimum link length, and an averaged link angle of a target interval, thereby enabling extraction of a singular curved interval with good precision even for a road shape accompanied by a large variance of sequential points included in point sequence data therefor. Further, there is acquired a curvature radius of the thus extracted curved interval by using the point sequence data within this curved interval, thereby enabling estimation of a curvature radius of a curved interval of a vehicle travel path with high precision without complicating the processing therefor, and enabling suitable indication of information, control of vehicle behavior, and the like without giving incongruent feeling to a driver.

The contents of Japanese Patent Application Nos. 2004-133240 and 2004-142199, filed to the Japanese Patent Office on Apr. 28, 2004 and May 12, 2004, respectively, are incorporated herein by reference.

Although the present invention has been described based on the embodiments, the present invention is not limited thereto, and various modifications may be made thereto without departing from the spirit or scope of the present invention.

1. A curvature radius estimating apparatus comprising:
a curvature radius calculator configured to use point sequence data which is included in map information and represents a road shape, to calculate a curvature radius of a curved interval of a travel path of a vehicle;
a shape pattern decider configured to use the point sequence data to decide a shape pattern of the curved interval of which the curvature radius is calculated by the curvature radius calculator, and
a curvature radius corrector configured to correct the curvature radius calculated by the curvature radius calculator, commensurately with a decision result by the shape pattern decider.

2. The curvature radius estimating apparatus as claimed in claim 1, further comprising:
a curved interval extractor configured to select a preset interval of the travel path of the vehicle as a target interval, and to extract, as a curved interval from the target interval, an interval where preset conditions are met by: an averaged value of link lengths representing spacings between sequential two points included in the point sequence data, respectively; a maximum value or minimum value of the link lengths; and an averaged value of link angles representing angles defined by adjacent two links, respectively; and
a curvature radius calculator configured to use the point sequence data within the curved interval extracted by the curved interval extractor, to acquire a curvature radius of the curved interval.

3. The curvature radius estimating apparatus as claimed in claim 2, wherein the curved interval extractor is configured to set the preset conditions, commensurately with a dimension of the curvature radius of the curved interval as the extraction target.

4. The curvature radius estimating apparatus as claimed in claim 3, wherein the curved interval extractor is configured to set the preset conditions, commensurately with a dimension of the curvature radius of the curved interval as the extraction target and correspondingly to a road type of the target interval.

5. The curvature radius estimating apparatus as claimed in claim 3, wherein the curved interval extractor is configured to set the preset conditions, commensurately with a dimension of the curvature radius of the curved interval as the extraction target and correspondingly to the number of sequential points constituting the point sequence within the target interval.

6. The curvature radius estimating apparatus as claimed in claim 2, wherein the curved interval extractor is configured to select an arbitrary point ahead of the vehicle along the travel path as a starting point, to select a point present within a preset distance from the starting point along the travel path of the vehicle as an ending point, and to set an interval between the staring point and ending point as the target interval.

7. The curvature radius estimating apparatus as claimed in claim 6, wherein the curved interval extractor is configured to set the preset distance, commensurately with the dimension of the curvature radius of the curved interval as the extraction target.

8. The curvature radius estimating apparatus as claimed in claim 6, wherein the curved interval extractor is configured to select that point, when present, as an ending point of the target interval, which point is located between the starting point and a point away from the starting point by a preset distance along the travel path of the vehicle, and which point has the number of branches equal to or greater than a preset value.

9. The curvature radius estimating apparatus as claimed in claim 6, wherein the curved interval extractor is configured to select that point, when present as an ending point of the target interval, which point is located between the starting point and a point away from the starting point by a preset distance along the travel path of the vehicle, and which point has a sign of a link angle different from that at a point just preceding thereto.

10. The curvature radius estimating apparatus as claimed in claim 9, wherein the curved interval extractor is configured to treat three successive points including a first point a second point, and a third point located between the starting point and a point away from the starting point by a preset distance along the travel path of the vehicle, to select the second point as an ending point of the target interval when the first point has a link angle sign different from that of the second point and the second point has the same link angle sign as that of the third point.

11. The curvature radius estimating apparatus as claimed in claim 2, further comprising a curved interval corrector configured to correct an ending point of the curved interval extracted by the curved interval extractor to a point just preceding to the ending point, when a link length between the point just preceding to the ending point and the ending point is longer than, by a preset value, an averaged value of link lengths of an interval between the starting point of the curved interval and the point just preceding to the ending point within the curved interval.

12. The curvature radius estimating apparatus as claimed in claim 1, wherein the shape pattern decider is configured to decide the curved interval the curvature radius of which is calculated by the curvature radius calculator, to be a shape pattern requiring a curvature radius correction, when preset conditions are met by lengths of links preceding to and following the curved interval, the number of sequential points constituting the point sequence of the curved interval, an averaged value of link lengths within the curved interval, and an averaged value of link angles within the curved interval, and
wherein the curvature radius corrector is configured to decreasingly correct the curvature radius calculated by the curvature radius calculator, when the shape pattern decider has decided the curved interval the curvature radius of which is calculated by the curvature radius calculator, to be a shape pattern requiring a curvature radius correction.

13. The curvature radius estimating apparatus as claimed in claim 12, wherein the curvature radius corrector is configured to set a decreasing correction amount for the curvature radius of the curved interval calculated by the curvature radius calculator, commensurately with the lengths of links preceding to and following the curved interval.

14. The curvature radius estimating apparatus as claimed in claim 1, wherein the shape pattern decider is configured to decide the curved interval the curvature radius of which is calculated by the curvature radius calculator, to be a shape pattern requiring a curvature radius correction, when preset conditions are met by an averaged link length and an averaged link angle of an interval configured with points the number of which is equal to or smaller than a predetermined number, within the curved interval, and
wherein the curvature radius corrector is configured to increasingly correct the curvature radius calculated by the curvature radius calculator, when the shape pattern decider has decided the curved interval the curvature radius of which is calculated by the curvature radius calculator, to be a shape pattern requiring a curvature radius correction.

15. The curvature radius estimating apparatus as claimed in claim 14, wherein the curvature radius corrector is configured to set an increasing correction amount for the curvature radius of the curved interval calculated by the curvature radius calculator, commensurately with the averaged link length of the interval configured with points the number of which is equal to or smaller than the predetermined number, within the curved interval.

16. The curvature radius estimating apparatus as claimed in claim 14, wherein the curvature radius corrector is configured to set an increasing correction amount for the curvature radius of the curved interval calculated by the curvature radius calculator, commensurately with the averaged link angle of the interval configured with points the number of which is equal to or smaller than the predetermined number, within the curved interval.

17. A curvature radius estimating apparatus comprising:
curvature radius calculating means for using point sequence data which is included in map information and represents a road shape, to calculate a curvature radius of a curved interval of a travel path of a vehicle;
shape pattern deciding means for using the point sequence data to decide a shape pattern of the curved interval of which the curvature radius is calculated by the curvature radius calculating means; and
curvature radius correcting means for correcting the curvature radius calculated by the curvature radius calculating means, commensurately with a decision result by the shape pattern deciding means.

18. A curvature radius estimating method, comprising:
using point sequence data which is included in map information and represents a road shape, for calculation to determine a curvature radius of a curved interval of a travel path of a vehicle;
using the point sequence data to decide a shape pattern of the curved interval of which the curvature radius is calculated by the calculation; and
correcting the curvature radius calculated by the calculation, commensurately with a decision result by the deciding operation.

19. A curvature radius estimating method of using point sequence data which is included in map information and represents a road shape, for calculation to determine a curvature radius of a curved interval of a travel path of a vehicle; the method comprising:
selecting a preset interval of the travel path of the vehicle as a target interval, and extracting, as a curved interval from the target interval, an interval meeting preset conditions on: an averaged value of link lengths representing spacings between sequential two points included in the point sequence data, respectively, a maximum value or minimum value of the link lengths; and an averaged value of link angles representing angles defined by adjacent two links, respectively; and
using the point sequence data within the curved interval extracted by said extracting, to acquire a curvature radius of the curved interval.
